(19) United States
(12) Patent Application Publication
(10) Pub. No.: US 2022/0390362 A1
(43) Pub. Date: Dec. 8, 2022

(54) REMOTE MEASUREMENT OF CROP STRESS

(71) Applicant: MIGAL APPLIED RESEARCH LTD., Kiryat Shmona (IL)

(72) Inventors: Oded LIRAN, Kiryat Shmona (IL); Lilach HOLTZMAN, Kibbutz Merom Golan (IL)

(73) Assignee: MIGAL APPLIED RESEARCH LTD., Kiryat Shmona (IL)

(21) Appl. No.: 17/774,469

(22) PCT Filed: Nov. 5, 2020
(86) PCT No.: PCT/IL2020/051155

§ 371 Date: May 4, 2022

Related U.S. Application Data
(60) Provisional application No. 62/931,243, filed on Nov. 6, 2019.
(60) Provisional application No. 63/015,591, filed on Apr. 26, 2020.

(51) Int. Cl. G01N 21/359; G01N 21/84; G06N 20/00; G06F 15/78

(52) U.S. Cl. CPC G01N 21/359; G01N 21/84; G06N 20/00; G06F 15/78; G01N 2021/8466

(57) ABSTRACT

A method comprising: receiving, as input, a plurality of spectral data samples, wherein each of the spectral data samples represents spectral reflectance from a plant; at a training stage, training a machine learning model on a training set comprising: (i) the spectral data samples, and (ii) labels associated with stomatal conductance in each of the plants; and at an inference stage, applying the machine learning model to a target spectral data sample associated with a target plant, to predict a stomatal conductance value for the target plant.

### CROSS-REFERENCE TO RELATED APPLICATIONS

This application claims the benefit of priority of U.S. Provisional Patent Application No. 62/931,243 filed on Nov. 6, 2019, and U.S. Provisional Patent Application No. 63/015,591 filed on Apr. 26, 2020, the contents of which are incorporated herein by reference in their entirety.

### FIELD OF THE INVENTION

The present invention relates to the field of machine learning.

Fertilization and irrigation are two of the key factors in crop treatment that can affect the yield and quality of cultivated crops. Inadequate crop treatment may cause crop stress that hinders growth. Thus plant water stress state is an important basis for water and fertilizer management. Water is the central molecule in all physiological processes of plants, and performs a crucial role as a medium for transporting metabolites and nutrients through different parts of the plant. Drought is a situation that lowers plant water potential and turgor to the extent that plants face difficulties in executing normal physiological functions. Water stress is primarily caused by water deficit, i.e., drought or high soil salinity.

However, detecting stress is agricultural plants presents several challenges. For example, various crops react differently to water stress. Some crops may sustain longer periods of drought before showing typical symptoms of water stress. Other crops may show water stress symptoms even while irrigated properly.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a method comprising: receiving, as input, a plurality of spectral data samples, wherein each of the spectral data samples represents spectral reflectance from a plant; at a training stage, training a machine learning model on a training set comprising: (i) the spectral data samples, and (ii) labels associated with stomatal conductance in each of the plants; and at an inference stage, applying the machine learning model to a target spectral data sample associated with a target plant, to predict a stomatal conductance value for the target plant.

There is also provided, in an embodiment, a system comprising at least one hardware processor; and a non-transitory computer-readable storage medium having stored thereon program instructions, the program instructions executable by the at least one hardware processor to: receive, as input, a plurality of spectral data samples, wherein each of the spectral data samples represents spectral reflectance from a plant; at a training stage, train a machine learning model on a training set comprising: (i) the spectral data samples, and (ii) labels associated with stomatal conductance in each of the plants; and at an inference stage, apply the machine learning model to a target spectral data sample associated with a target plant, to predict a stomatal conductance value for the target plant.

There is further provided, in an embodiment, a computer program product comprising a non-transitory computer-readable storage medium having program instructions embodied therewith, the program instructions executable by at least one hardware processor to: receive, as input, a plurality of spectral data samples, wherein each of the spectral data samples represents spectral reflectance from a plant; at a training stage, train a machine learning model on a training set comprising: (i) the spectral data samples, and (ii) labels associated with stomatal conductance in each of the plants; and at an inference stage, apply the machine learning model to a target spectral data sample associated with a target plant, to predict a stomatal conductance value for the target plant.

In some embodiments, the spectral data samples in the training set are labeled with the labels.

in some embodiments, the spectral data samples are obtained by measuring reflected light from a canopy of the plant.

in some embodiments, the spectral data samples are obtained by remote sensing techniques.

In some embodiments, the method further comprises, and the program instructions are further executable to preprocess, a preprocessing step configured for reducing a number of wavelengths in each of the spectral data samples.

In some embodiments, the preprocessing comprises at least one of: box-car averaging, removal of outlier spectra, applying standard normal variate (SNV) analysis, base-line correction, normalization to the maximum peak within each spectrum, and scaling.

In some embodiments, the method further comprises performing, and the program instructions are further executable to perform, a feature selection stage to select an optimal subset of wavelengths from the reduced number of wavelengths, wherein the training set comprises only the optimal subset of spectral bands from each of the spectral data samples.

In some embodiments, the feature selection stage is performed using a regression tree algorithm.

In some embodiments, the regression tree algorithm is a random forest algorithm with pruning.

In some embodiments, the stomatal conductance is indicative of a water stress status in the target plant.

There is further provided, in an embodiment, a system comprising: a non-transitory computer-readable storage medium having stored thereon program instructions, the program instructions executable by the at least one hardware processor to: receive spectral data representing spectral reflectance from a plant, wherein the spectral data comprises: (i) spectral data in a spectral band comprising wavelengths from 1087-1273 nm; and (ii) spectral data in at least one spectral band selected from the group of spectral bands comprising wavelengths from: 673 nm-785 nm, 800 nm-844 nm, 891 nm-1025 nm, and 1341 nm-1661 nm; and predict a stomatal conductance value for the target plant, based on the received spectral data.

There is further provided, in an embodiment, a method for remote sensing of stomatal conductance in a plant, the method comprising: receive spectral data representing spectral reflectance from a plant, wherein the spectral data comprises: (i) spectral data in a spectral band comprising wavelengths from 1087-1273 nm; and (ii) spectral data at least one spectral band selected from the group of spectral bands comprising wavelengths from: 673-785 nm, 800-844 nm, 891-1025 nm, and 1341-1661 nm; and predicting a stomatal conductance value for the target plant, based on the received spectral data.

There is further provided, in an embodiment, a computer program product comprising a non-transitory computer-readable storage medium having program instructions embodied therewith, the program instructions executable by at least one hardware processor to: receive spectral data representing spectral reflectance from a plant, wherein the spectral data comprises: (i) spectral data in a spectral band comprising wavelengths from 1087-1273 nm; and (ii) spectral data in at least one spectral band selected from the group of spectral bands comprising wavelengths from: 673 nm-785 nm, 800 nm-844 nm, 891 nm-1025 nm, and 1341 nm-1661 nm; and predict a stomatal conductance value for the target plant, based on the received spectral data.

In some embodiments, the spectral data is received from an imaging module comprising a set of imaging sensors, each configured to capture spectral reflectance in only one spectral band selected from the group of spectral bands comprising wavelengths from: 673-785 nm, 800-844 nm, 891-1025 nm, 1087-1273 nm, and 1341-1661 nm.

There is further provided, in an embodiment, a method for remote sensing of stomatal conductance in a plant, the method comprising: receiving, as input, a plurality of spectral data samples, wherein each of the spectral data samples represents spectral reflectance from a plant in a set of spectral wavelengths; applying a random forest regression tree algorithm to the spectral data samples, to identify a subset of the spectral wavelengths, based on a spectral wavelength importance measure, wherein the random forest regression tree algorithm comprises pruning associated with at least one of: (i) a total number of decision trees; (ii) a constant value of samples within a single node of each of the decision trees; and (iii) a maximum depth of the regression tree; receiving a target spectral data sample associated with a target plant; and predicting a stomatal conductance value for the target plant, based on the spectral data associated with the subset of spectral wavelengths in the spectral data sample.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary system 100 for automated remote detection of a water stress status in plants, in accordance with some embodiments of the present invention;

FIG. 2 is a flowchart of the functional steps in a process for automated remote detection of a water stress status in plants, in accordance with some embodiments of the present invention;

FIG. 3 illustrates an exemplary spectral reflectance profile of a cotton plant, obtained using a suitable spectrometry device;

FIGS. 4A-4D show the results of an exemplary random forest feature selection step, in accordance with some embodiments of the present invention;

FIG. 5A illustrates an exemplary neural network for use in conjunction with a machine learning model of the present disclosure, in accordance with some embodiments of the present invention;

FIG. 5B shows the results of a machine learning model optimization process, in accordance with some embodiments of the present invention;

FIGS. 5C-5D show the results of a validation stage of a trained machine learning model of the present disclosure, in accordance with some embodiments of the present invention.

FIGS. 6A-6D shows examples of data received during one instance of a 2-year experiment, in accordance with some embodiments of the present invention;

FIGS. 7A-7D show a Normalized Differential Spectral Index (NDI) of spectral data collected over a two year experiment with cotton plants, in accordance with some embodiments of the present invention;

FIGS. 8A-8K are a presentation of all the Random Forest (RF) parameters combinations and their respective RMSE values, in accordance with some embodiments of the present invention;

FIGS. 9A-9D shows construction of stomatal conductance index with Partial Least Squares Regression, in accordance with some embodiments of the present invention;

FIG. 10 shows results of stomatal conductance calculation by a trained machine learning model of the present disclosure, compared to the actual acquired data, in accordance with some embodiments of the present invention; and

FIGS. 11A-11D, 12, and 13A-13B show additional experimental results.

### DETAILED DESCRIPTION

Disclosed are a method, system, and computer program product for automated and accurate remote detection of a water stress status in plants.

In some embodiments, the present disclosure provides for evaluating plant water stress, based, at least in part, on analyzing features associated with spectral reflectance from the plant. In some embodiments, the spectral reflectance features from the plant provide an indication of stomatal conductance in the plant, wherein stomatal conductance is indicative of a water stress status in the plant.

Several physiological indicators may be used to assess plant water status, or stress, with stomatal conductance, leaf water potential, and transpiration rate the most widely used. Typically, the earliest responses to water deficit stress involve minimizing stomatal conductance in the plant, to lower the amount of water loss through transpiration and enhance water-use efficiency. However, by lowering substomatal CO₂ concentration, this mechanism leads to a decrease in photosynthetic rate during the early stage of mild and moderate water deficit stresses. Additionally, the decrease in stomatal aperture size under prolonged water deficit stress is associated with adjustments of leaf area at the whole-plant level. The leaf area of the canopy is adjusted either through the earlier senescence of older leaves or via a reduction in leaf development. This drought-avoidance mechanism leads to decreased transpiration rate, but also results in a decrease in intercepted radiation, which ultimately leads to a reduction in biomass accumulation. Accordingly, monitoring of stomatal conductance may be indicative of these responses at a canopy scale.

Hyperspectral reflectance sensing techniques are based on plant optical reflectance and absorption properties at the visible-infrared (VIS, 400 nm-700 nm), near-infrared (NIR, 700 nm-1300 nm), and/or shortwave-infrared (SWIR, 1300 nm-2500 nm) wavelengths or spectral bands. In general, the metrics of spectral reflectance received from biological matter are dependent on the optical properties of the captured objects. Hence, the spectral reflectance received from a plant may depend on optical properties of the plant, with particular regard to properties related to light absorption and scattering. For example, when a light beam having a specific intensity and wavelength is radiated at a biological object irradiation point, part of this light beam is diffusely reflected from the surface of the object, while another part of the light beam passes through the surface into the tissue of the object, and distributes there by means of multiple scattering. A fraction of this light scattered in the tissue exits back out from the surface as visible scattered light, whereby the intensity of this scattered light depends on the distance of the exit point from the irradiation point as well as on the wavelength of the light radiated in. This dependence is caused by the optical properties of the biological matter. For example, different spectral bands (with different wavelengths) of the spectrum have different absorption levels in biological tissue. Thus, different absorption levels of different wavelengths can lead to different metrics of spectral reflectance. Accordingly, these unique optical properties may be used for sensing, detection, and monitoring purposes.

The terms “spectrum” and “spectral band” as used herein refer to specific wavelength ranges of the electromagnetic spectrum within and/or near the visible spectrum.

Plant reflectance and absorption properties have been demonstrated to represent biophysical and biochemical characteristics of the plant which are sensitive to water deficit stress. These properties give spectral reflectance data a great potential for use in detecting and quantifying stress-related plant parameter.

Accordingly, in some embodiments, the present disclosure provides for obtaining spectral reflectance measurements from a plant. In some embodiments, spectral reflectance measurements are obtained, e.g., with respect to a specified portion or area of the plant, or with respect to an entire canopy of the plant.

In some embodiments, the spectral measurements are obtained remotely, e.g., through remotely-located optical spectrometers and/or multi-spectral and/or hyperspectral one or more imaging devices. In some embodiments, the imaging devices may be placed, e.g., overhead relative to the plant, to measure spectral reflectance from, e.g., a canopy of the plant.

In some embodiments, the present disclosure provides for scaling up remote sensing and detection of water stress in plants, e.g., to provide for water stress detection with respect to multiple plants or crops, e.g., at a field, orchard, vineyard, grove, and/or forest environment.

In some embodiments, the measured spectral reflectance may be processed to provide for dimensionality reduction and/or selection of those wavelengths and/or spectral bands that are the most highly correlated with predicting stomatal conductance in the plant.

In some embodiments, the present disclosure provides for selecting a subset of spectral bands and/or specified spectral wavelengths acquired as spectral reflectance from a plant, as most predictive spectral bands and/or spectral wavelengths with respect to remotely sensing stomatal conductance in a plant. In some embodiments, a selected subset of spectral bands and/or specified spectral wavelengths determined as most predictive spectral bands and/or spectral wavelengths with respect to remotely sensing stomatal conductance in a plant, may comprise one or more of the following spectral bands and/or specified spectral wavelengths selected from one or more of the following spectral bands:
(i) 673 nm-785 nm: Spectral range which includes Red Edge;
(ii) 800 nm-844 nm: Spectral range associated with disease-related indices;
(iii) 891 nm-1025 nm: Spectral range comprising a water absorption band;
(iv) 1087 nm-1273 nm: Spectral range associated with lignin content in a plant; and/or
(v) 1341 nm-1661 nm: Spectral range associated with a water absorption band and/or amount of cellulose and starch in a plant.

In some embodiments, the present disclosure provides for selecting a subset of spectral bands and/or specified spectral wavelengths acquired as reflectance from a plant, wherein the selected subset comprises spectral bands and/or wavelengths determined as most predictive spectral bands and/or spectral wavelengths with respect to remotely sensing stomatal conductance in a plant, and wherein the selected subset comprises any combination of one or more spectral bands and/or spectral wavelengths selected from the following spectral bands: 673 nm-785 nm; 800 nm-844 nm; 891 nm-1025 nm; 1087 nm-1273 nm; and/or 1341 nm-1661 nm, e.g., 1087 nm-1273 nm and 673 nm-785 nm, or 1087 nm-1273 nm and 800 nm-844 nm, or 1087 nm-1273 nm and 891 nm-1025 nm, or 1087 nm-1273 nm and 1341 nm-1661 nm, or 673 nm-785 nm and 800 nm-844 nm, or 673 nm-785 nm and 891 nm-1025 nm, or 673 nm-785 nm and 1341 nm-1661, or 800 nm-844 nm and 891 nm-1025 nm, or 800 nm-844 nm and 1341 nm-1661 nm, or 891 nm-1025 nm and 1341 nm-1661 nm, or 1087 nm-1273 nm and 673 nm-785 nm and 800 nm-844 nm, or 1087 nm-1273 nm and 673 nm-785 nm and 891 nm-1025 nm, or 1087 nm-1273 nm and 673 nm-785 nm and 1341 nm-1661 nm, or 673 nm-785 nm and 800 nm-844 nm and 891 nm-1025 nm, or 673 nm-785 nm and 800 nm-844 nm and 1341 nm-1661 nm, or 800 nm-844 nm and 891 nm-1025 nm and 1341 nm-1661, or 673 nm-785 nm and 800 nm-844 nm and 891 nm-1025 nm and 1087 nm-1273 nm; or 673 nm-785 nm and 800 nm-844 nm and 891 nm-1025 nm and 1341 nm-1661 nm or 673 nm-785 nm and 800 nm-844 nm and 1087 nm-1273 nm and 1341 nm-1661 nm, or 673 nm-785 nm and 891 nm-1025 nm and 1087 nm-1273 nm and 1341 nm-1661 nm, or 800 nm-844 nm and 891 nm-1025 nm and 1087 nm-1273 nm and 1341 nm-1661 nm. Each option represents a separate embodiment and can be combined.

In some embodiments, the present disclosure provides for selecting a subset of spectral bands and/or specified spectral wavelengths acquired as reflectance from a plant, wherein the selected subset comprises spectral bands and/or wavelengths determined as most predictive spectral bands and/or spectral wavelengths with respect to remotely sensing stomatal conductance in a plant, and wherein the selected subset comprises one or more spectral wavelengths selected from the spectral band 1087 nm-1273 nm, in combination with any one or more spectral bands and/or one or more spectral wavelengths selected from the following spectral bands: 673 nm-785 nm; 800 nm-844 nm; 891 nm-1025 nm; and/or 1341 nm-1661 nm, e.g., 1087 nm-1273 nm and 673 nm-785 nm, or 1087 nm-1273 nm and 800 nm-844 nm, or 1087 nm-1273 nm and 891 nm-1025 nm, or 1087 nm-1273 nm and 1341 nm-1661 nm; or 1087 nm-1273 nm and 673 nm-785 nm and 800 nm-844 nm, or 1087 nm-1273 nm and 673 nm-785 nm and 800 nm-844 nm and 891 nm-1025 nm, or 1087 nm-1273 nm and 673 nm-785 nm and 800 nm-844 nm and 891 nm-1025 nm and 1341 nm-1661 nm, or 1087 nm-1273 nm and 673 nm-785 nm and 891 nm-1025 nm, or 1087 nm-1273 nm and 673 nm-785 nm and 1341 nm-1661 nm, or 1087 nm-1273 nm and 673 nm-785 nm and 891 nm-1025 nm and 1341 nm-1661 nm, or 1087 nm-1273 and 800 nm-844 nm and 891 nm-1025 nm, or 1087 nm-1273 and 800 nm-844 nm and 891 nm-1025 nm and 1341 nm-1661 nm, or 1087 nm-1273 and 891 nm-1025 nm and 1341 nm-1661 nm, or 1087 nm-1273 891 nm-1025 nm and 1341 nm-1661 nm. Each option represents a separate embodiment and can be combined.

According to some aspects, there is provided a method for remote sensing of stomatal conductance in a plant, the method comprising: receiving spectral data representing spectral reflectance from a plant; and predicting a stomatal conductance value for the target plant, based on the spectral data. In some embodiments the spectral data comprises one, two, three, four, five, or more, e.g., between 1-50 or 1-100 specified wavelengths, wherein the specified wavelengths are selected from at least one, at least two, at least three, at least four, or all five spectral band from the group of spectral bands consisting of or the group of spectral bands comprising of: 673 nm-785 nm, 800 nm-844 nm, 891 nm-1025 nm, 1087 nm-1273 nm, and 1341 nm-1661 nm. Each option represents a separate embodiment and can be combined. In some embodiments, the predicting is based on calculating differences between said spectral data and known values.

According to some aspects, there is provided a method for remote sensing of stomatal conductance in a plant, the method comprising: receiving spectral data representing spectral reflectance from a plant; and predicting a stomatal conductance value for the target plant, based on the spectral data. In some embodiments the measured spectral reflectance comprises one, two, three, four, five, or more, e.g., between 1-50 or 1-100 specified wavelengths, wherein the specified wavelengths are selected from (i) the spectral band 1087 nm-1273 nm, and (ii) at least one, at least two, at least three, or all four spectral bands selected from the group of spectral bands consisting of or the group of spectral bands comprising of: 673 nm-785 nm, 800 nm-844 nm, 891 nm-1025 nm, and 1341 nm-1661 nm. Each option represents a separate embodiment and can be combined. In some embodiments, the predicting is based on calculating differences between said spectral data and known values.

In some embodiments, the present study provides for one or more machine learning models configured to predict stomatal conductance values out of spectral information.

In some embodiments, a machine learning model of the present disclosure may be trained to predict a water stress state in a plant, based, at least in part, on a training set comprising a plurality of feature sets representing spectral reflectance measurements in multiple plants, wherein the feature sets may be labeled with labels representing ground-truth stomatal conductance measurements in these plants. In some embodiments, a trained machine learning model of the present disclosure may then be applied to a target feature set representing spectral reflectance measurements in a target plan, to predict stomatal conductance in the target plant.

In some embodiments, a machine learning model of the present disclosure comprises an Artificial Neural Network (ANN) consisting, e.g., of inputs nodes that receive the data, i.e., selected wavelengths for prediction of stomatal conductance. In some embodiments, the data are then transferred forward towards a hidden layer where they receive new values via a non-linear transfer functions (usually a sigmoid function), and then they are transferred again into the output nodes, this time with a linear function. In some embodiments, at the end, the ANN calculates values of stomatal conductance and compares it to the original values. The weight functions which were created along the way, together with a bias term, will be attenuated over and over until the weight function is optimized and the bias function is minimized.

A potential advantage of the present disclosure is, therefore, in that it provides for measuring water stress status of crops remotely and for whole plants and/or whole fields, without requiring usage and/or installation or specialized equipment in the field and without the need to adhere to labor-intensive operational procedures.

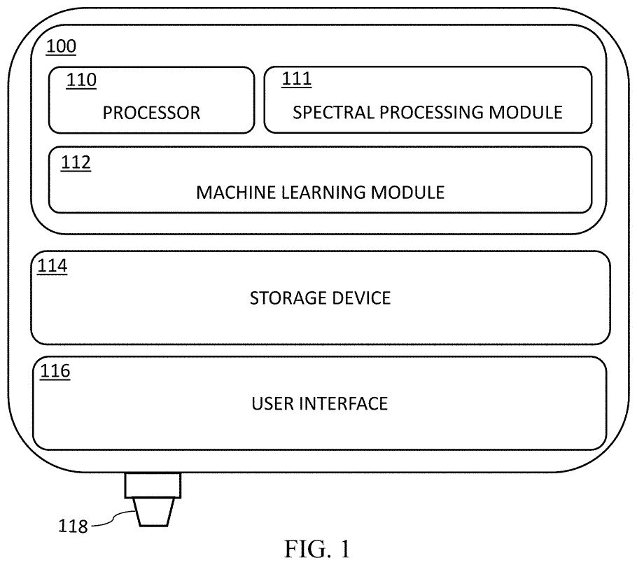

FIG. 1 illustrates an exemplary system 100 for automated remote detection of a water stress status in plants, in accordance with some embodiments of the present invention.

The various components of system 100 may be implemented in hardware, software or a combination of both hardware and software. system 100 as described herein is only an exemplary embodiment of the present invention, and in practice may have more or fewer components than shown, may combine two or more of the components, or may have a different configuration or arrangement of the components. In some embodiments, system 100 and/or components thereof may be configured for implementing in the context of an aerial and/or any other above-ground imaging platform.

In some embodiments, system 100 may include a hardware processor 110, a spectral processing module 111, a machine learning module 112, a memory storage device 114, a user interface 116, an imaging sensor 118. System 100 may store in a non-volatile memory thereof, such as storage device 114, software instructions or components configured to operate a processing unit (also “hardware processor,” “CPU,” or simply “processor”), such as hardware processor 110. In some embodiments, the software components may include an operating system, including various software components and/or drivers for controlling and managing general system tasks (e.g., memory management, storage device control, power management, etc.) and facilitating communication between various hardware and software components.

In some embodiments, imaging sensor 118 may include one or more imaging sensors, for example, which may capture one or more image data streams. In some embodiments, imaging sensor 118 may comprise one or more of optical spectrometer, multispectral sensors, hyperspectral sensors, RGB sensors, and the like.

In some embodiments, imaging sensor 118 comprises a set of imaging sensors, each configured to capture spectral reflectance in only one spectral band selected from the group of spectral bands comprising wavelengths from: 673-785 nm, 800-844 nm, 891-1025 nm, 1087-1273 nm, and 1341-1661 nm.

In some embodiments, imaging sensor 118 is configured to capture spectral reflectance comprising at least one, two, three, four, five or more, e.g., between 1-50 or between 1-100 specified wavelengths, wherein the specified wavelengths are selected from at least one, at least two, at least three, at least four, or all five spectral band from the group of spectral bands consisting of or the group of spectral bands comprising of: 673 nm-785 nm, 800 nm-844 nm, 891 nm-1025 nm, 1087 nm-1273 nm, and 1341 nm-1661 nm. Each option represents a separate embodiment and can be combined.

In some embodiments, imaging sensor 118 is configured to capture spectral reflectance comprising at least one, two, three, four, five or more, e.g., between 1-50 or between 1-100 specified wavelengths, wherein the specified wavelengths are selected from (i) the spectral band 1087 nm-1273 nm, and (ii) at least one, at least two, at least three, or all four spectral bands selected from the group of spectral bands consisting of or the group of spectral bands comprising of: 673 nm-785 nm, 800-844 nm, 891-1025 nm, and 1341-1661 nm. Each option represents a separate embodiment and can be combined.

In some embodiments, imaging sensor 118 is configured to capture spectral reflectance in bands comprising wavelengths from: 1087 nm-1273 nm and 673 nm-785 nm, or 1087 nm-1273 nm and 800 nm-844 nm, or 1087 nm-1273 nm and 891 nm-1025 nm, or 1087 nm-1273 nm and 1341 nm-1661 nm, or 673 nm-785 nm and 800 nm-844 nm, or 673 nm-785 nm and 891 nm-1025 nm, or 673 nm-785 nm and 1341 nm-1661, or 800 nm-844 nm and 891 nm-1025 nm, or 800 nm-844 nm and 1341 nm-1661 nm, or 891 nm-1025 nm and 1341 nm-1661 nm, or 1087 nm-1273 nm and 673 nm-785 nm and 800 nm-844 nm, or 1087 nm-1273 nm and 673 nm-785 nm and 891 nm-1025 nm, or 1087 nm-1273 nm and 673 nm-785 nm and 1341 nm-1661 nm, or 673 nm-785 nm and 800 nm-844 nm and 891 nm-1025 nm, or 673 nm-785 nm and 800 nm-844 nm and 1341 nm-1661 nm, or 800 nm-844 nm and 891 nm-1025 nm and 1341 nm-1661, or 673 nm-785 nm and 800 nm-844 nm and 891 nm-1025 nm and 1087 nm-1273 nm; or 673 nm-785 nm and 800 nm-844 nm and 891 nm-1025 nm and 1341 nm-1661 nm or 673 nm-785 nm and 800 nm-844 nm and 1087 nm-1273 nm and 1341 nm-1661 nm, or 673 nm-785 nm and 891 nm-1025 nm and 1087 nm-1273 nm and 1341 nm-1661 nm, or 800 nm-844 nm and 891 nm-1025 nm and 1087 nm-1273 nm and 1341 nm-1661 nm. Each option represents a separate embodiment and can be combined.

In some embodiments, imaging sensors 118 may comprise one or more imaging sensors configured each to capture spectral reflectance in a specified spectral band and/or in one or more specified wavelengths within the specified spectral band. Accordingly, in some embodiments, imaging sensor 118 may comprise one or more imaging sensors, each configured to capture spectral reflectance in only one of the following spectral bands: 673 nm-785 nm; 800 nm-844 nm; 891 nm-1025 nm; 1087 nm-1273 nm; and/or 1341 nm-1661 nm. In some embodiments, imaging sensor 118 may comprise one or more imaging sensors, each configured to capture spectral reflectance in one or more specified spectral wavelengths in only one of the following spectral bands: 673 nm-785 nm; 800 nm-844 nm; 891 nm-1025 nm; 1087 nm-1273 nm; and/or 1341 nm-1661 nm.

According to some aspects, there is provided a method for remote sensing of stomatal conductance in a plant, the method comprising: operating a spectral reflectance imaging module to measure spectral reflectance from a plant; and predicting a stomatal conductance value for the target plant, based on the measured spectral reflectance. In some embodiments the measured spectral reflectance comprises one, two, three, four, five, or more, e.g., between 1-50 or 1-100 specified wavelengths, wherein the specified wavelengths are selected from at least one, at least two, at least three, at least four, or all five spectral band from the group of spectral bands consisting of or the group of spectral bands comprising of: 673 nm-785 nm, 800 nm-844 nm, 891 nm-1025 nm, 1087 nm-1273 nm, and 1341 nm-1661 nm. Each option represents a separate embodiment and can be combined.

According to some aspects, there is provided a method for remote sensing of stomatal conductance in a plant, the method comprising: operating a spectral reflectance imaging module to measure spectral reflectance from a plant; and predicting a stomatal conductance value for the target plant, based on the measured spectral reflectance. In some embodiments the measured spectral reflectance comprises one, two, three, four, five, or more, e.g., between 1 nm-50 or 1 nm-100 specified wavelengths, wherein the specified wavelengths are selected from (i) the spectral band 1087 nm-1273 nm, and (ii) at least one, at least two, at least three, or all four spectral bands selected from the group of spectral bands consisting of or the group of spectral bands comprising of: 673 nm-785 nm, 800 nm-844 nm, 891 nm-1025 nm, and 1341 nm-1661 nm. Each option represents a separate embodiment and can be combined.

In some embodiments, imaging sensor 118 is configured to capture spectral reflectance comprising at least one, two, three, four, five or more, e.g., between 1 nm-50 or between 1 nm-100 specified wavelengths, wherein each wavelength is selected from (i) the spectral band 1087 nm-1273 nm, and (ii) at least one, at least two, at least three, or all four spectral band selected from the group of spectral bands consisting of or the group of spectral bands comprising of: 673 nm-785 nm, 800 nm-844 nm, 891 nm-1025 nm, and 1341 nm-1661 nm. Each option represents a separate embodiment and can be combined.

The software instructions and/or components operating hardware processor 110 may include instructions for receiving and analyzing spectral data captured by imaging sensor 118. For example, spectral processing module 111 may receive spectral data from imaging sensor 118 or from any other interior and/or external device, and apply one or more processing algorithms thereto.

In some embodiments, processor 110 may be configured to perform and/or to trigger, cause, control and/or instruct system 100 to perform one or more functionalities, operations, procedures, and/or communications, to generate and/or communicate one or more messages and/or transmissions, and/or to control hardware processor 110, spectral processing module 111, machine learning module 112, memory storage device 114, user interface 116, imaging sensor 118, and/or any other component of system 100.

In some embodiments, spectral processing module 111 may include one or more algorithms configured to perform processing tasks with respect to spectral data captured by imaging sensor 118 or by any other interior and/or external device, using any suitable processing or feature extraction technique. The spectral data received by the spectral processing module 111 may vary in aspects and properties, including with respect to the number of received spectral bands and/or wavelengths. received resolution, frame rate, format, and protocol.

In some embodiments, machine learning module 112 is a machine learning model which may be configured to be trained on a training set comprising a plurality of data and labels, and to classify target input data according into specified classes according to one or more classification techniques and/or algorithms.

In some embodiments, user interface 116 may include circuitry and/or logic configured to interface between system 100 and a user of system 100. user interface 116 may be implemented by any wired and/or wireless link, e.g., using any suitable, Physical Layer (PHY) components and/or protocols.

In some embodiments, system 100 may further comprise a GPS module which may include a Global Navigation Satellite System, e.g., which may include a GPS, a GLObal NAvigation Satellite System (GLONASS), a Galileo satellite navigation system, and/or any other satellite navigation system configured to determine positioning information based on satellite signals. In some embodiments, GPS module may include an interface to receive positioning information from a control unit and/or from any other external system.

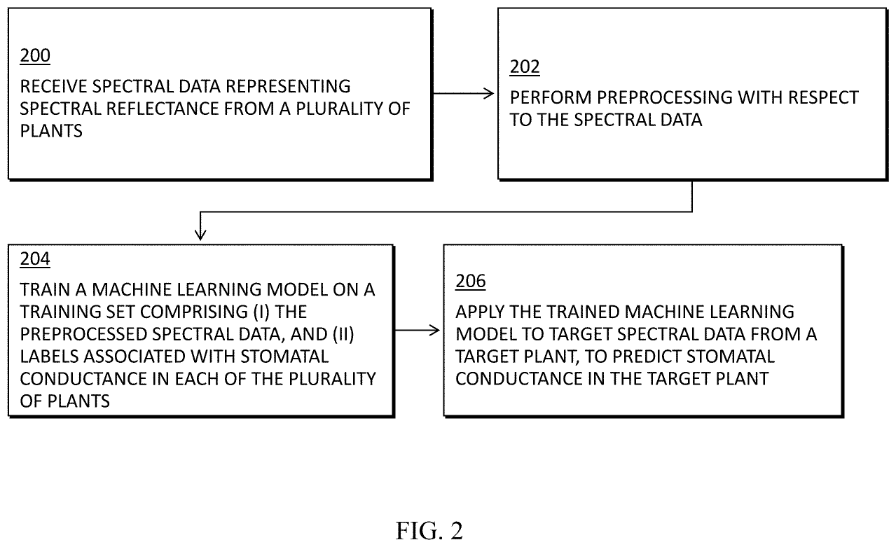

FIG. 2 is a flowchart of the functional steps in a process for automated remote detection of a water stress status in plants, in accordance with some embodiments of the present invention.

In some embodiments, at step 200, a system of the present disclosure, such as exemplary system 100 described with reference to FIG. 1, may receive, as input, a plurality of spectral data samples, wherein each of the spectral data samples represents spectral reflectance from a plant.

The spectral image data may be received from, e.g., any spectral imaging device, e.g., a spectroradiometer configured to measure light reflected from a plurality of plant canopies, and/or any other region of a plant. The spectral imaging device may be mounted on any platform, which may be ground-based or airborne, configured to measure spectral image data from above a canopy.

In some embodiments, at step 202, a preprocessing stage may take place comprising one or more of noise reduction, data normalizing, feature selection, feature extraction, and/or dimensionality reduction.

In some embodiments, preprocessing may comprise method configured for reducing a number of wavelengths in the obtained spectral data. In some embodiments, preprocessing may comprise at least one of box-car averaging, removal of outlier spectra, applying standard normal variate (SNV) analysis, base-line correction, normalization to the maximum peak within each spectrum, and scaling.

In some embodiments, preprocessing may comprise a feature selection stage to select an optimal subset of wavelengths from the spectral data. In some embodiments, the feature selection stage is performed using a regression tree algorithm, e.g., a random forest algorithm with pruning.

In some embodiments, at step 204, a training stage may take place, wherein a machine learning model may be trained using a training set comprising:
(i) The spectral data obtained at step 200 and preprocessed at step 202, and
(ii) labels associated with stomatal conductance measured empirically in each of the plurality of plants, wherein the stomatal conductance is indicative of a water stress status in the plants.

In some embodiments, at step 206, the trained machine learning model may be applied to target spectral data associated with a target plant, to predict a stomatal conductance value for the target plant.

### Initial Experimental Results

The present inventors conducted an initial field experiment to obtain relevant spectral reflectance profiles of plants. In the initial experiment, the plants were cotton plants, however, other and/or additional types of plants, trees, vegetation, shrubs, and/or crops may be used.

Accordingly, cotton plants were arranged in three plots, each comprising various cotton cultivars irrigated based on various irrigation protocols. Each plot included 576 pots arranged in random blocks with four irrigation treatments per three cotton cultivars, and four pots in a quad in order to receive a closed canopy and twelve biological repeats.

Each of the three plots was tended based on a different irrigation scheme, e.g.:
Protocol A: Irrigation shut-off for 24 hours and then replenishing water back in four different rates per day (one, two, three and four times irrigation volume per day) for a week, followed by zeroing treatment with maximum irrigation for an additional week.
Protocol B: Irrigation in a gradient over a period of two months of wild type cotton crops.
Protocol C: Irrigation in a gradient over a period of two months of commercial cultivars of cotton (Pima, Akala and Akalpi).

Fertilization of the plots was calculated per the total volume of water the crop received, in order to avoid salinization of the soil.

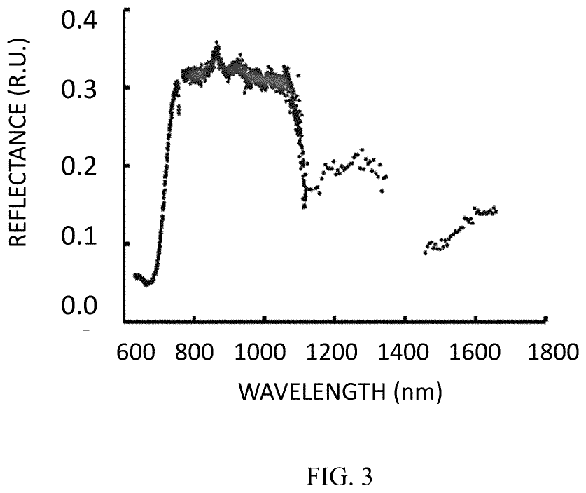

FIG. 3 illustrates an exemplary spectral reflectance profile of a cotton plant, obtained using suitable imaging sensors. For example, in the experiment described above, four passive optical spectrometers were positioned to image the plots in pairs, wherein each pair comprises a Near Infra-Red range (633-1150 nanometer) microspectrometer (STS-VIS developer kit, OceanOptics Ltd., USA) and a Short Wave Infra-Red range (1000 nm-1659 nanometer) microspectrometer (Flame developer kit, OceanOptics Ltd., USA). The spectrometer pairs were positioned so as to image crop canopies. One of the pairs acted as a reference unit and was used in conjunction with a 94% white plate (Permaflect, LabSphere, USA).

In the initial experiment, the obtained image data was preprocessed in accordance with several procedures. In some embodiments, such preprocessing steps may comprise, e.g.:
Noise reduction by subtraction of dark current from raw data, e.g., by

Vegetation/Referencespectra=Vegetation_{λ},Reference_{λ}−Vegetation^{dark-current}^{_{λ}},Reference^{dark-current}^{_{λ}}.
Physical units conversion with a calibration vector related to each of the four spectrometers in the initial experiment. The calibration vector was constructed separately by using a NIST calibrated light source (HL-2000, Ocean Optics, USA).
Spectrally corrected magnitude:

Vegetation/Reference spectra=Reduced noise Vegetation/Reference*Calibration Vector.
Spectrally corrected wavelengths values of Vegetation/Reference spectra=>X-axis shift according to the Fraunhoffer absorption line at 760 nanometer.
Division by the pupil geometry for light penetrating into the sensor, wherein the same opening was used on all four spectrometers. Accordingly, each of the vectors was divided by 0.0055 Sr (Steradian), which is the calculation of the solid angle of the radius of the SMA-905 opening.
Multiplication of the Reference spectrum by 2*π. This is because the reference target was cosine corrected Permaflect plate (Labsphere, Fla., USA).
Division by the nominal difference vector (the wavelengths difference on the x-axis) for each of the four spectrometers.
Reflectance profile generation for each two of the spectrometers NIR-STS/FLAME:

$$ρ ( R . U . ) = \frac{{( \frac{R}{{R}_{0}} )}^{2} Vegetation}{Refe rence \cdot cos ( θ )} ,$$

where, R is the distance of earth from the sun, and the θ represents 90—the angle between the sun and the normal to the ground.

In some embodiments, other and/or additional preprocessing steps may be performed with respect to the spectral reflectance image data obtained, e.g., box-car averaging, removal of outlier spectra, applying standard normal variate (SNV) analysis, base-line correction, normalization to the maximum peak within each spectrum, and scaling.

Once a set of spectral profile samples was obtained for each plant in the initial experiment, the present inventors performed further processing to obtain a training set. In some embodiments, such further processing may provide for feature selection and/or dimensionality reduction, to select those features which are most relevant, best explain, and/or contribute the most to the prediction varibale of interest. In some embodiments, techniques such as CART (Classification and Regression Trees, see, e.g., Breiman, L. (2001) Random Forests. Machine Learning, 45, 5-32. http://dx.doi.org/10.1023/A:1010933404324) may be used in order to search for the most influential wavelengths out of a total number of 1,222 wavelengths that potentially correlate with a stomatal conductance parameter measured in the plants during the initial experiment. In some embodiments, other and/or additional feature selection and/or dimensionality reduction methods and techniques may be used. In some embodiments, the regression tree algorithm is configured to minimize an evaluation metric, e.g., Root Mean Square Error (RMSE), to select a subset of input features.

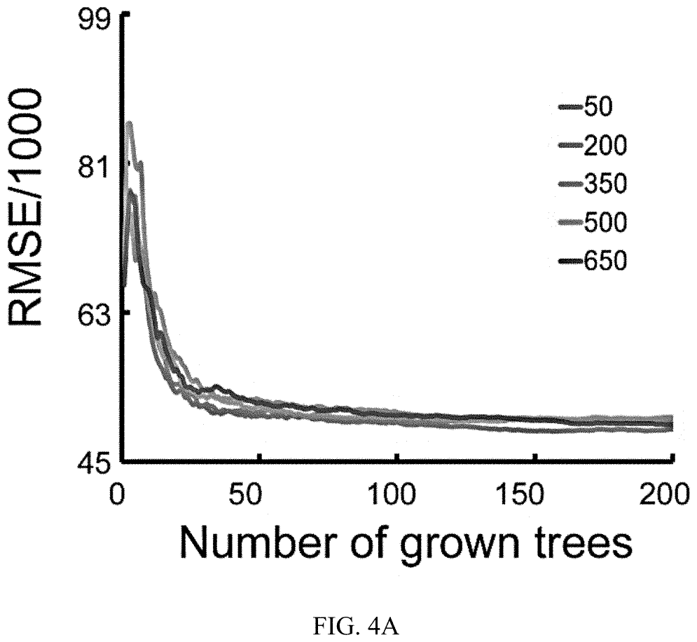

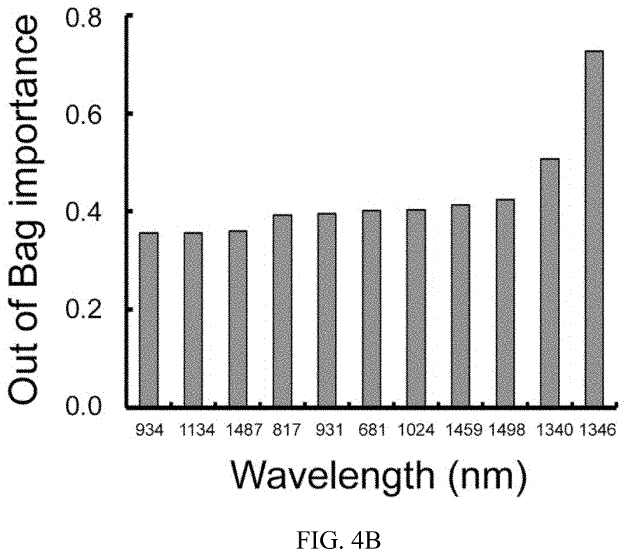

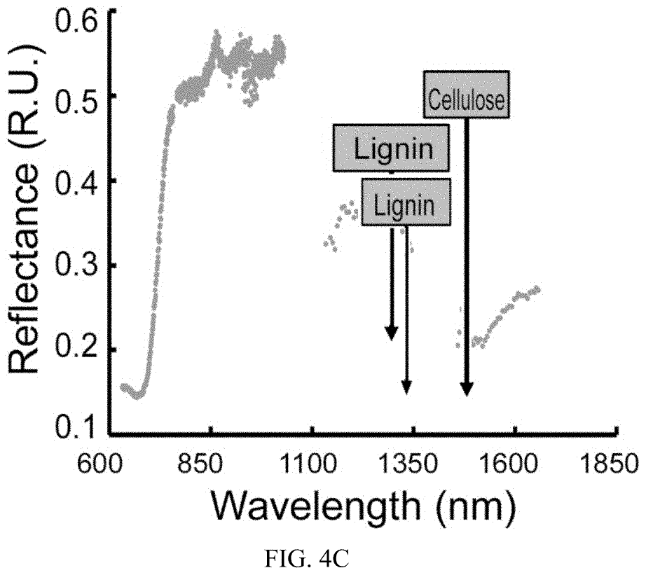

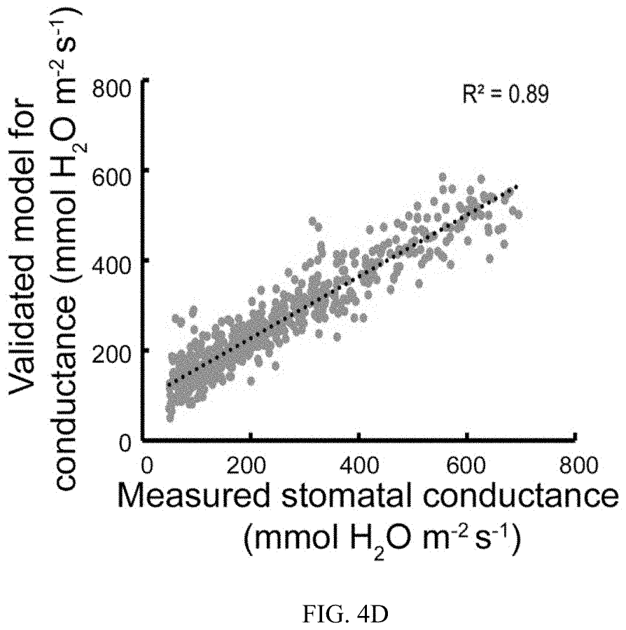

In the initial experiment, within the multiple iterations of random forest performed, those features (e.g., specified wavelength) that were deemed to be the most relevant were retained. FIG. 4A shows the combinations used in order to create the random forest, where the x axis represents the number of trees grown, and the series determines the number of branches per tree. Each forest iteration runs through randomly-selected subsets out of the 1,222 wavelength, together with a random selection of subsets out of the samples. Then stomatal conductance by the linear combination of the wavelengths is compared to the value of stomatal conductance measured for this sample, and an RMSE value is calculated. The lower the RMSE, the better is the forest prediction of features importance. In the initial experiment, there were found 96 wavelengths (out of 1,222 in total) as the most important in predicting a stomatal conductance parameter measured in the plants. FIG. 4B is a graph showing the first ten features of the 96 so selected.

The present inventors have further found biological relevance which explains the importance of the selected wavelengths in terms of predicting stomatal conductance. The three most influencing wavelengths selected during the feature selection process were those associated with the presence of lignin in the plants under observation, i.e., 1340 nm, 1346 nm, and 1459 nm (see FIG. 4C; see, e.g., Curran, P. J. (1989) Remote Sensing of Foliar Chemistry. Remote Sensing of Environment, 30, 271-278). Lignin is a class of complex organic bio-polymers that form key structural materials in the support tissues of vascular plants. When lignin concentration in the veins of a plant is high, it is coincident with high stomatal conductance. This coincidence may help to explain and verify the present results of the feature selection stage.

FIG. 4D illustrates the validation for the technique, by comparing results between the measured and predicted stomatal conductance, based on the 96 features (i.e., wavelengths) selected by the random forest, including the three lignin-related wavelengths. The high correlations shows that these 96 features best predict stomatal conductance in plants.

In some embodiments, the present disclosure provides for training a machine learning model to predict stomatal conductance in plants based, at least in part, on spectral reflectance measurements.

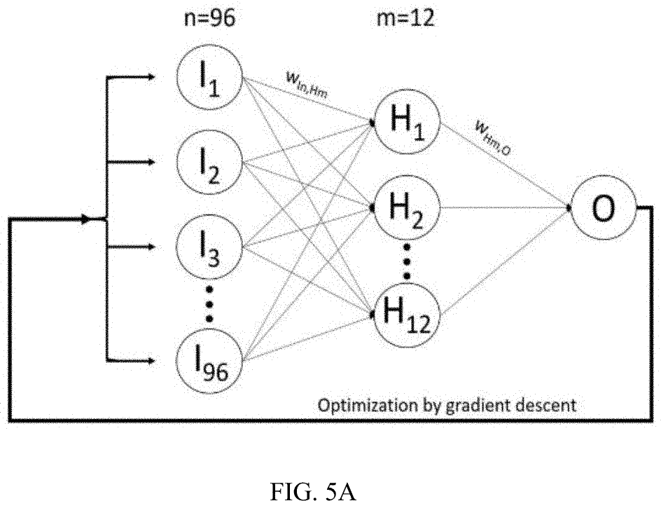

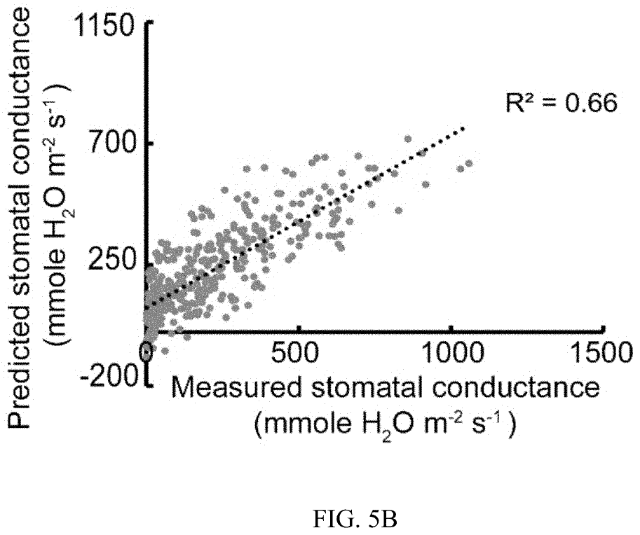

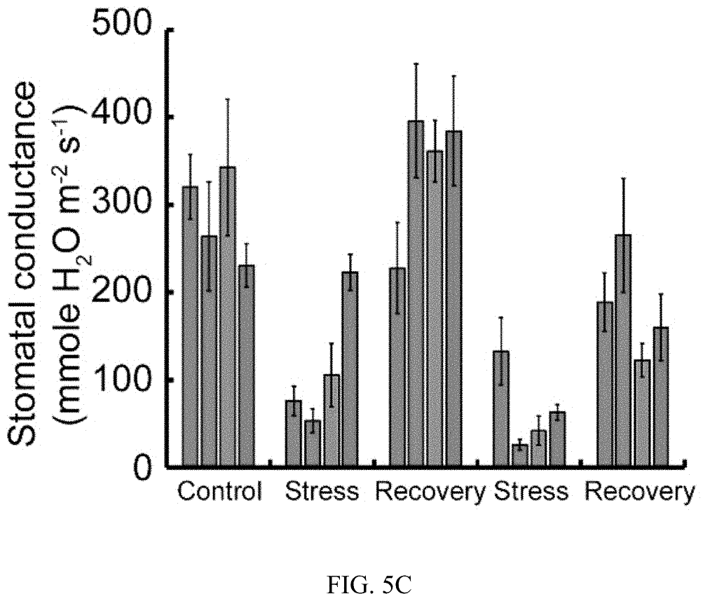

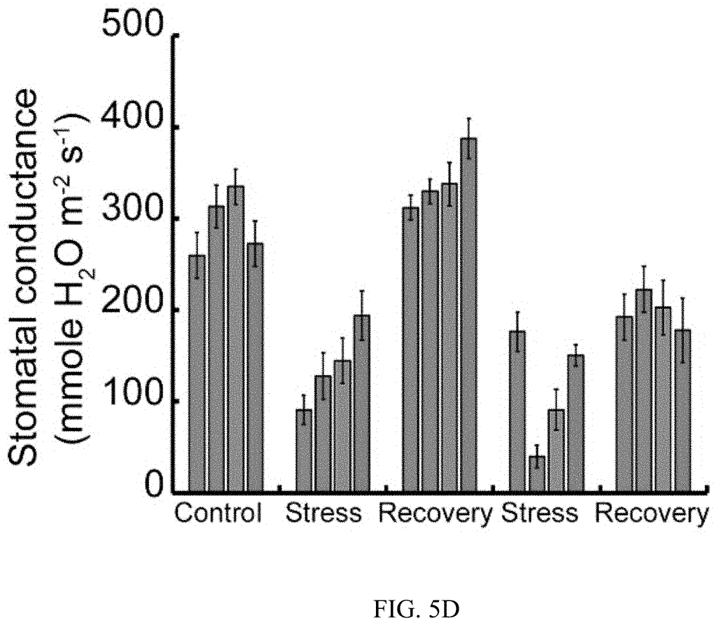

FIG. 5A illustrates an exemplary neural network which may, in some embodiments, used as a prediction model in connection with the present disclosure. In some embodiments, an exemplary neural network of the present disclosure may comprise a back propagation neural network that contains, e.g., 96 input nodes (Iₙ), 12 hidden calculation nodes in one hidden layer (Hₘ) and one output node (O). In order to predict unknown stomatal conductance out of obtained spectral reflectance data, the available sample dataset was divided into a training subset (comprising 70% of the samples) and validation subset (30% of the samples). The training subset comprised 530 spectral data samples, each containing 96 wavelengths, wherein each sample is associated with a ground-truth stomatal conductance measurement. These training samples were fed to neural network, wherein the value of each wavelength is multiplied by a weight value (w_{i,H}_{ₘ}) and put into each of 12 hidden nodes within the hidden layer (Hₘ). At the end of this step, each of the hidden nodes includes 96 values of the original wavelengths multiplied by an arbitrary starting value weight. The 96 values are then transferred to a new single value by, e.g., a sigmoid transfer function:

$$f ( x ) = \frac{2}{( 1 + {e}^{- 2 x} ) - 1} ,$$

such that each of the hidden nodes includes a single value at the end of this step. Next, each of the 12 hidden nodes values are again transferred to the output node (O), and are multiplied by an arbitrary weight value (w_{H}_{ₘ}_{,o}). At the end of the transfer, the output node includes 12 new values. These are then transferred to a single value by using simple additive function to receive a single value as the output number.

At a network optimization stage, an optimization function was used, where p designates the number of samples in the training sub-set:

$$Loss = \frac{1}{2} {{\sum }^{p}}_{i = 1} {( {O}_{p} - {stomatal}_{p} )}^{2}$$

The optimization function was iterated on the model in order to minimize the loss and adjust the weights in a gradient descent process. The results of the maximum convergence of the optimization process are seen in FIG. 5B. The present inventors performed 1000 iterations on each sample, for a total of 530,000 runs, in order to reach convergence.

In some embodiments, in order to avoid over-fitting of the model on noise, a Bayesian regularization algorithm may be applied to the training data subset. This will result in a weight matrix that is confined within limits of reason, based a-priori (Bayes theorem) assumptions performed on the stomatal conductance values distribution and the biases (the errors in the model) of the neural network.

Finally, the results were analyzed using the validation data subset in order to evaluate how well the network calculates stomatal conductance from a new target data sample and search for a biological significance in the results. While the error bars of the ground-truth technique are quite large (FIG. 5C), the general correlation between stomatal conductance (y axis) and plant stress level (x axis) is observable. The results are more pronounced (FIG. 5D) when using the neural network, with smaller standard errors.

### Expanded Experimental Results

The present inventors have conducted an expanded 2-year experiment concerning irrigation methods on cotton plants during the years 2018-2019. In some embodiments, by adding an additional year of experimentation, the model developed herein may be better able to generalize over a change in different environmental conditions over multiple years.

Table 1 below describes some of the meteorological and environmental conditions during the experiment.

TABLE 1

| | | | | | | | | Average |
|---|---|---|---|---|---|---|---|---|
| | | | | | Wind | Light | | Air |
| | | | | VP [symbol] | Speed | Intensity | RH^{†} | Temp. |
| # | Year | Date | Time | (kPa) | (ms⁻¹) | (Wm⁻²) | (%) | (° C.) |
| 1 | 2018 | 25.06 | 11:00 | 2.88 | 2 | 994 | 39.9 | 32.1 |
| | | | 12:30 | 3.26 | 3.7 | 1030 | 36.6 | 33.4 |
| 2 | | 26.06 | 10:30 | 2.52 | 2 | 993 | 46.7 | 31.9 |
| | | | 12:00 | 3.18 | 4.4 | 1049 | 37.8 | 33.3 |
| 3 | | 02.07 | 10:30 | 2.37 | 1.0 | 938.5 | 48.1 | 31.2 |
| | | | 13:00 | 3.95 | 2.2 | 1003 | 33.3 | 35.9 |
| 4 | | 03.07 | 10:30 | 2.51 | 1.6 | 973 | 46.7 | 31.8 |
| | | | 13:00 | 3.25 | 1.8 | 997 | 40.5 | 34.4 |
| 5 | | 09.07 | 10:30 | 2.91 | 1.3 | 990 | 42.7 | 33.2 |
| | | | 12:00 | 3.63 | 1.4 | 1036.0 | 36 | 35.2 |
| 6 | | 10.07 | 10:30 | 3.12 | 1.4 | 988 | 38.3 | 33.1 |
| | | | 11:30 | 3.68 | 2.9 | 1051 | 31.6 | 34.2 |
| 7 | | 16.07 | 10:30 | 2.88 | 1.1 | 952 | 42.1 | 32.8 |
| | | | 13:00 | 3.92 | 2.3 | 983 | 36.7 | 36.7 |
| 8 | | 17.07 | 10:30 | 2.53 | 1.8 | 946 | 49 | 32.7 |
| | | | 13:00 | 3.09 | 3.7 | 999 | 45.1 | 35 |
| 9 | | 30.07 | 10:30 | 2.53 | 3.1 | 742.3 | 46.5 | 31.9 |
| | | | 13:00 | 3.01 | 4.5 | 1028 | 40.8 | 33.2 |
| 10 | | 09.08 | 10:30 | 2.63 | 1.7 | 920 | 49.6 | 33.7 |
| | | | 11:30 | 3.43 | 1.8 | 954 | 40.7 | 35.5 |
| 1 | 2019 | 05.08 | 10:30 | 1.77 | 1.4 | 820 | 60.2 | 30.9 |
| 2 | | 07.08 | 10:30 | 2.38 | 1 | 785.1 | 47.7 | 31.3 |
| | | | 12:30 | 3.1 | 1.3 | 930 | 41.4 | 33.9 |
| 3 | | 14.08 | 10:30 | 2.7 | 1.2 | 735.7 | 44.3 | 32.4 |
| 4 | | 15.08 | 10:30 | 2.16 | 2.2 | 766.2 | 52.7 | 31.3 |
| | | | 12:30 | 2.89 | 4.1 | 903 | 44.1 | 33.5 |
| 5 | | 21.08 | 10:30 | 2.67 | 2.3 | 766.5 | 44.6 | 32.2 |
| | | | 12:00 | 3.1 | 4.2 | 875 | 39.3 | 33.3 |
| 6 | | 26.08 | 10:30 | 2 | 1.2 | 740.5 | 55.6 | 31 |
| | | | 12:30 | 3.64 | 2.2 | 874 | 38.2 | 35.8 |
| 7 | | 28.08 | 10:30 | 2.12 | 0.6 | 695.6 | 55 | 31.9 |
| | | | 12:30 | 3.31 | 1.7 | 846 | 42.3 | 35.4 |
| 8 | | 02.09 | 10:30 | 2.18 | 0.7 | 739.5 | 52.3 | 31.3 |
| | | | 12:30 | 4.14 | 3.9 | 876 | 30.4 | 36 |
| 9 | | 04.09 | 10:30 | 1.83 | 0.5 | 737 | 54.3 | 29 |
| | | | 12:30 | 2.6 | 1 | 834 | 46.3 | 32.3 |
| 10 | | 09.09 | 10:30 | 1.8 | 0.7 | 704.3 | 57.6 | 30 |
| | | | 12:30 | 2.85 | 2 | 795 | 44.2 | 33.3 |

### Hyperspectral Data Acquisition Setup

The expanded experiment used four point microspectrometers (STS and Flame series, OceanInsight, USA), each pair together covering the spectral range of 633 nm-1659 nm, and mounted onto two platforms (ground and air) (see Burkart et al., 2014). Each spectrometer was radiometrically calibrated with a calibrated light source (HA-910, OceanInsight, USA) according to manufacturer's instructions. STS and Flame series obtain an overlapping region in the spectral range of 936 nm-1120 nm, and on this basis each two acquired spectrums were combined together.

Overall, 1,222 wavelengths were obtained, with 1 nm and 6 nm FWHM spectral resolution for STS and FLAME series spectrometers, respectively. The air unit was mounted on top of a trolley with a boom situating the spectrometer pupil at a constant distance of 2.5 meters above the canopy of the crops. This means that the height of the boom and air unit was gradually increasing with the growth of the crop in order to maintain a constant height over the target. The ground unit was situated above a 94% reflectance Permaflect white plate (LabSphere, USA). Spectrometers combined spectra were spectrally calibrated according to Fraunhoffer Oxygen absorption line at 759.3 nm. Small deviations on the spectral range between each of the two units were corrected according to Rascher's suggestion (see Rascher et al., 2015), and radiometric deviations between the two units were corrected as well (when both are pointing at the reference plate), such that at the end, the Oxygen absorption line at 759.3 nm obtained the same magnitude and physical properties between the two units. Reflectance signatures were calculated and corrected for meteorological conditions according to Gordon and Wang's study (see Gordon and Wang, 1994)

### 2018 Experimental Setup

Three types of cotton plants—G. hirsutum, G. barbadense & G. akalpi—were sowed such that four seeds of each type in square geometry were sowed in their own pot (3.9 L), filled with mixed ground (80%:20% Peat soil:Clay, Kekkila BVB, Sweden). After emergence, the two weakest plants within each pot were removed. There were total of 432 pots which were divided into two different irrigation experiments, and 54 quads of pots (18 biological repeats per cotton type). Each four pots within a quad were situated closely such that early in the season, the canopies of the crop were closing the view above the ground. The distance between neighboring quads was no less than 50 cm. Each of the two pot plots contained a different experiment: a. Irrigation volume gradient; b. Irrigation shut-off.

### Volume Gradient Experiment

54 pots quads were randomly distributed within the plot and were divided into four irrigation volume treatments such that the water potential (Scholander bomb, MRC, Israel) measured at noon reflected the plant's need for water. The four treatments and their corresponding water potentials were: 4 L (16 Bar), 3 L (18 Bar), 2 L (20 Bar), 1 L (22 Bar) per day. Each pot received two dripping lines with a fertigation solution such that the fertilizer concentration was relative to the irrigation volume (Sheffer+3 micro, ICL, Israel). Hyperspectral measurements and concurrent porometer measurements (AP4, Delta-t, UK) were performed ten times per quad in the course of two months, twice a day (once at early noon, and then again at noon, see table 1 for meteorological conditions during the measurements), covering the vegetative growth, transfer to, and start of the reproductive growth stage.

### Irrigation Shut-Off Experiment

54 pot quads were randomly distributed within this plot as well. Here, all the quads received optimal irrigation volume which was determined as 3 L per day (18 Bars at noon). At t=0 the irrigation was stopped for 24 hours and then resumed in an irrigation gradient with the same four volumes per day described above for a week. Hyperspectral and ground truth measurements were performed before t=0, before irrigation resumed, and one week later after receiving the gradient volume treatments.

### 2019 Irrigation Gradient Experiment

G. akalpi cotton plant was sowed into 288 pots, each pot included 4 seeds in square geometry, and soil content as the year before. The 288 pots were divided into 72 pots quads that were organized in random in two plots with no less than 50 cm distance between each quad. The 72 quads were further divided into 4 irrigation treatments (18 biological repeats per treatment) similar to the year the before, however the water potential range was expanded to include: 12, 18, 22, 25 Bars. It was done so, because not many differences were visualized in view of the stomatal conductance between the highly irrigated treatments the year before. The crops were let grow on optimal irrigation which was set at 18 Bars and during the week of the measurement, they were irrigated in the determined gradient. Measurements with hyperspectral sensors and stomatal conductance (this time with Li-Cor 6800 Photosynthesis system, Li-Cor biosciences, USA) were performed twice a day along 29 dates along the season (Table 1).

### Data Preprocessing

In some embodiments, a box-car averaging technique may be used in order to create an even nominal pace between the two sides of the stitched spectra. In some embodiments, this step may result in, e.g., selecting 231 wavelengths out of the 1,222 total wavelength of the raw data.

In some embodiments, follow-up steps may comprise identifying and removing outlier spectra by, e.g., Cochran's test (Cochran, 1941), as well as applying standard normal variate (SNV) analysis in order to correct for multiple scatter (Barnes et al., 1989).

In some embodiments, spectra may be corrected for additive dispersion effect with base-line correction, and normalized to the maximum peak within each spectrum. In some embodiments, this may result in part of the water absorption spectrum between 1380-1450 nm to become negative, thus removing from consideration wavelengths within this region.

Finally, in some embodiments, the spectra may be mean-centered and standardized before performing further analysis.

In some embodiments, reference stomatal conductance data may be searched for outliers per irrigation treatments, where in case sample values which are deviate from the average by more than one standard deviation may be removed. Also, only two treatments out of the total of four treatments during 2018 were taken for analysis in the combined data set—those of the 18 and 20 Bars water potential. Eventually out of a total of about 1000 points in the starting data set for the two years of study, 648 samples and spectra were carried following preprocessing analysis.

### Wavelength Selection

In some embodiments, a normalized Difference Index combinations technique, also termed contour-contour map (see Inoue et al., 2012), may be used in order to search for the most influential wavelengths out of a total number of 231 wavelengths that potentially correlate with a stomatal conductance parameter measured in the plants during the expanded experiment.

In order to avoid over-fitting of a possible regression forest (see Liaw & Wiener, 2002), pruning of the forest (Nan et al., 2016) may be performed in three levels:
(i) Numbers of trees in the forest (50, 100, 250, 500);
(ii) constant value of samples within one node (leaf) (10, 20, 30, 40% of the data); and
(iii) maximum depth of the regression tree (up to two thirds of an average maximum depth reached in preliminary iterations on the data-set).

In some embodiments, the present method may comprise an Ensemble method of random forest of regression trees.

### Construction of a Stomatal Conductance Index

In some embodiments, the dataset may be divided into 75% data calibration and 25% data testing sub-sets.

In some embodiments, a machine learning model, e.g., an Artificial Neural Network (ANN) may be trained on the dataset to identify a relationship between each of the spectra predictors and the predictand, which in itself is a multi-level physiological process (Sousa et al., 2007). An exemplary ANN architecture (Cybenko, 1989) may include one hidden layer and a standard back-propagation process containing loss function (Hecht-Nielsen, 1992). Performance of the ANN was checked with a suite of statistical tests as suggested by (Sousa et al., 2007).

### Results and Discussion

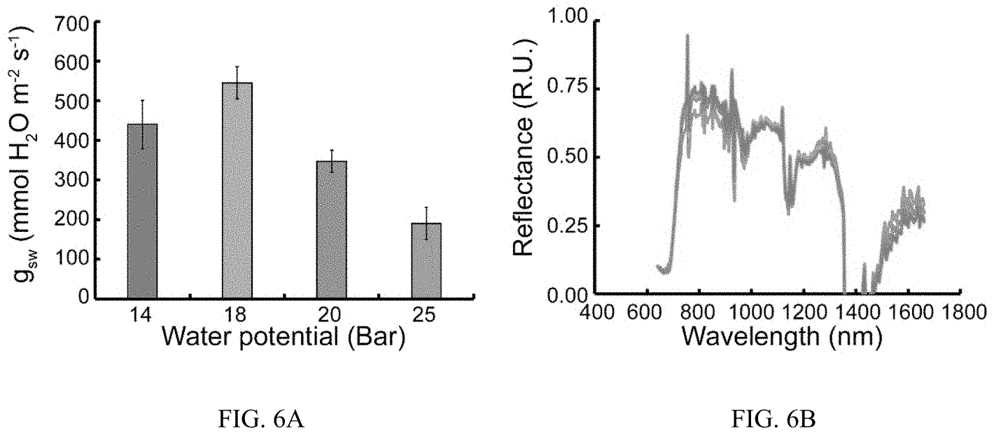

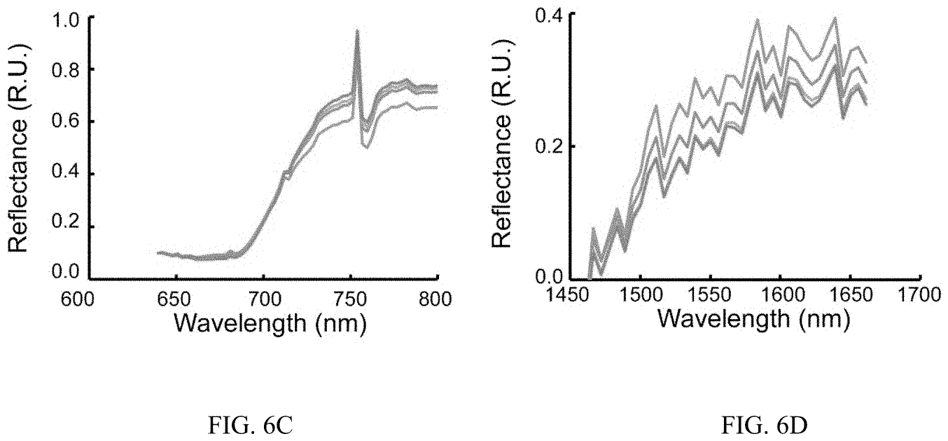

FIGS. 6A-6D show examples of data received during one instance of a 2-year experiment: 2 Jul. 2019 at 10:30 AM for Cotton plant G. akalpi. FIG. 6A shows four water potential treatments. The bars represent averaged values of stomatal conductance g_{sw} in (mmol H₂O m⁻²s⁻¹). N=at least four independent samples and error bars represent standard error of the mean. FIG. 6B shows outcome of pre-processing reflectance signature of cotton G. akalpi at four water potential treatments acquired with two spectrometers (NIR+SWIR). FIG. 6C-6D represent sub-regions within the electromagnetic spectrum where there is a correlation between spectra height and water potential treatments that are visible to the naked eye. FIG. 6B-6D were smoothly averaged with an 11 pace window for a qualitative purpose of presentation.

The expanded experimental setup allowed monitoring the stomatal conductance at two time ranges during the light hours-10:00-11:30 AM and 12:00 nm-13:30 PM. In the present experiment, at these hours there was an almost linear correlation between each of the water treatments and the stomatal conductance values measured (FIG. 6A). There was no difference between the two most irrigated treatments, where 14 and 18 bars showed the same stomatal conductance values. Per each of stomatal conductance measurement, spectral acquisition with our sensors was taken in parallel (FIG. 6B). While the Near Infra-Red (NIR) region was mostly visible, a portion of the Short-Wave Infra-Red (SWIR) region was kept out of construction of a remote sensing index for stomatal conductance (See the region between 1380-1450 nm in FIG. 6B). This region was kept out of analysis due to its noisy appearance. It happens because there is a strong absorption of a water band in these wavelengths region (C. L. Jones et al., 2004). The only visible difference can be seen between the 14 and 25 Bar water treatments. These are the two extreme conditions during that type of experiment—either over-irrigating the plant or wilting it until it reaches a very high water potential. When magnifying the spectral regions where an order of the spectra according to the treatments are witnessed, it can also be seen that the regions height are very similar to the relations between the stomatal conductance actual values (FIGS. 6C and 6D as compared to FIG. 6A). The magnitude of the spectrum in the region of the red-edge is rising with a decrease in water potential. This region has been long known to be related to plant stress (Smith et al., 2004). It happens because this region in the spectrum is layered with both physiological and chemical information. On the one hand it borders to the right the absorption of the photosynthetic pigments—Chl a and Chl b (Gitelson & Merzlyak, 1998), and on the other hand it reflects the photosynthetic activity of the crop (Zarco-Tejada et al., 2003). It is therefore not unexpected that as the plant is found in a better state, its red edge and specifically the difference between the maximum and minimum reflectance at this range is maximized. This difference, known as Normalized Differential Vegetation Index (NDVI) (Rouse, 1974), is yet another robust remote sensing index for the wellbeing of crops. On the other hand, the spectra present an opposite behavior of the SWIR region to that of the NIR (FIG. 6D). The SWIR region is affected by the water absorption bands, therefore it can be seen as opposite effect because as the plant obtains more water within its tissues, then the water absorbs more light and the reflectance at this region will decrease. The data discussed further is divided into two parts—Wavelengths selection and construction of a statistical model based on that selection.

### Wavelengths Selection

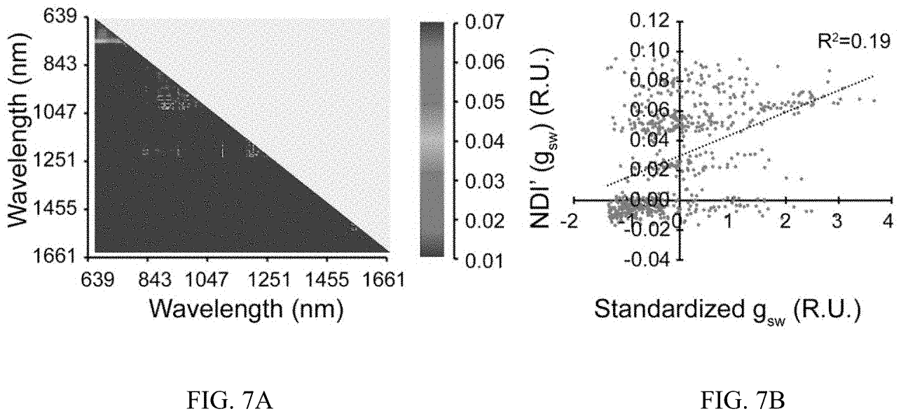

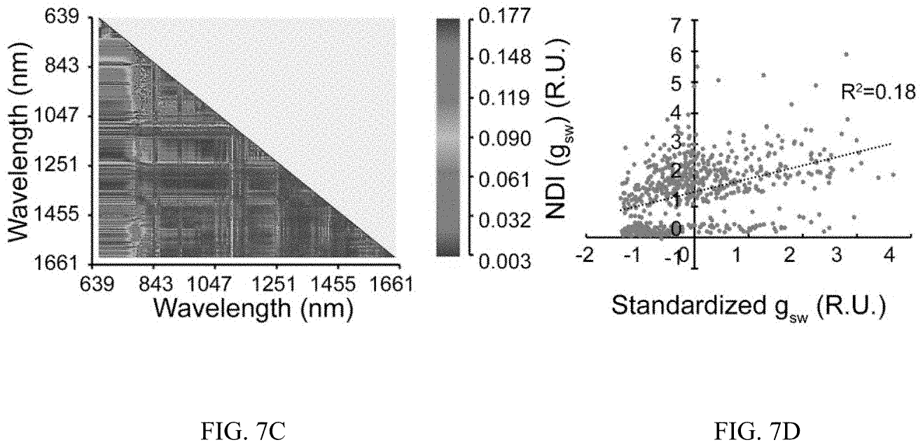

FIGS. 7A-7D shows a Normalized Differential Spectral Index (NDI) of spectral data collected over a two year experiment with cotton plants, in according to an embodiment. FIGS. 7A and 7C represent a 53,361 pixelated graph (for 231X231 wavelength combinations) where each pixel is colored by the coefficient of determination (R²) as is defined to the right of the graph. Only half of the pixels are shown as the grey area is their mirror image. FIGS. 7B and 7D represent the correlation between the calculated NDI with the maximum R². Each grey dot represents a stomatal conductance measurement out of the 658 samples of the dataset.

In some embodiments, a Normalized Difference Indices technique may be used to analyze the 231 wavelengths in the present dataset, to identify a “hot-spot” regions that are more correlated with the stomatal conductance values than the rest of the wavelength combinations (FIG. 7A): 693 nm-703 nm, 780 nm-890 nm, 1007 nm-1120 nm, 1500 nm-1560 nm. The first region relates to the red-edge spectral range and has been shown to relate to evapotranspiration in general (Marshall et al., 2016) with similar coefficient of determination value. The second range relates to the reflectance of the mesophyll tissue of the plant, and encompasses many different remote sensed traits such as nitrogen concentration (Lee et al., 2008), pest response related indices (Liu et al., 2011) and disease related indices (Zhao et al., 2012). The third region relates to water content and cellular structures such as lignin and cellulose which are part of the water transfer vessel network (Curran, 1989). The fourth region relates to starch molecules which relate indirectly to transpiration in that it is being synthesized as a transient product of photosynthesis within the leaves tissues, so it can be argued that with more stomatal conductance there is more starch created and hence the relation between spectral properties and chemical activity (Mehrotra & Siesler, 2003; Peet et al., 1986). However, the coefficient of determination is quite low, and on inspection of the correlation between the highest correlated wavelengths on this scale to stomatal conductance—1094 nm and 1096 nm, both in the region of the water content—it can be seen that its correlation is not strong (FIG. 7B). It may then be hypothesized that the detection of hotspots regions within the spectral field can be improved if a generalization of the method will take place. This means that instead just calculating the normalized difference between each two wavelengths, coefficients were added before each of the two wavelengths and an optimization model was run on each of the 2312 wavelength combinations. In such a case, the NDI method is a private case of the generalization where all the coefficients equal 1. Using this approach, wavelength combinations were found which have triple the coefficient of determination values found in the standard NDI case (FIGS. 7C and 7D). Here, the majority of high value correlations were at the red-edge region, from 639 nm-890 nm with an additional vertical hot-spot region spanning the range of the upper half of the red-edge region+mesophyll spectral range from 700 nm-780 nm. The maximum correlation was achieved for the two wavelength combination of 734 nm and 830 nm with R2=0.188. It was also pronounced that the vertical hot-spot region is active with any wavelength within our measurement's spectral range. Still it is visible that the correlation to the actual regression line is weak. A large number of wavelengths will increase by definition computational time. This happens due to the infinite possibilities of plant traits related to stomatal conductance and therefore infinite possibilities on the appearances of the reflectance spectrum. Therefore a different wavelength selection technique was searched for, that on the one hand can isolate a lower number of features from the spectral range (one feature in this sense is one wavelength), and on the other, take into account a non-linear relationship between the physiological phenomenon and the spectral information, as is expected from a biological activity and its possible spectral traits (Sellers, 1987).

Accordingly, a supervised machine learning algorithm comprising random forest (RF) of regression trees (Breiman, 2001) was chosen.

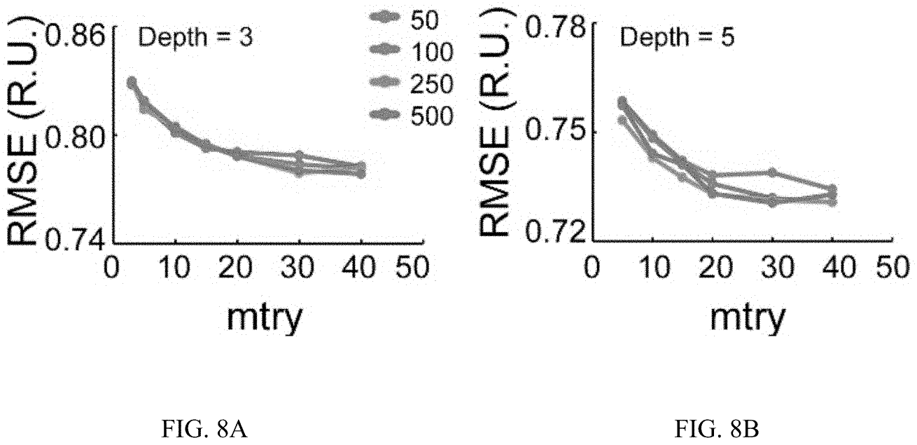

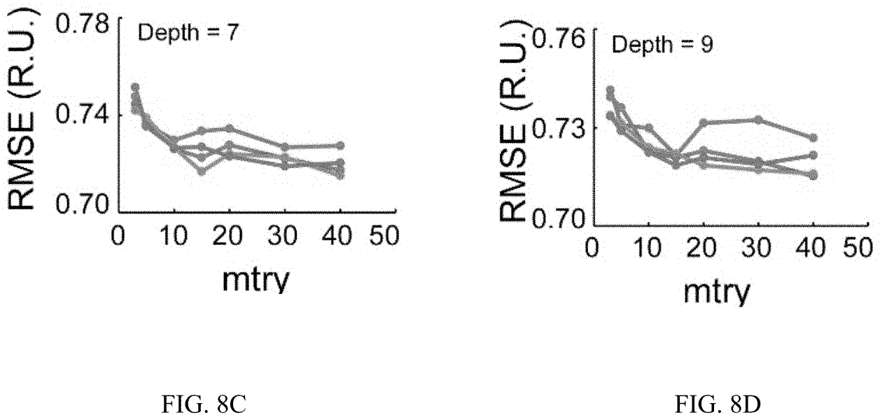

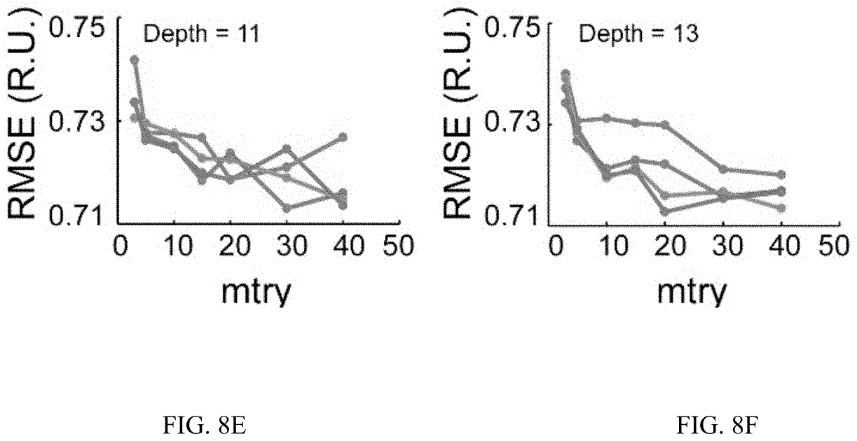

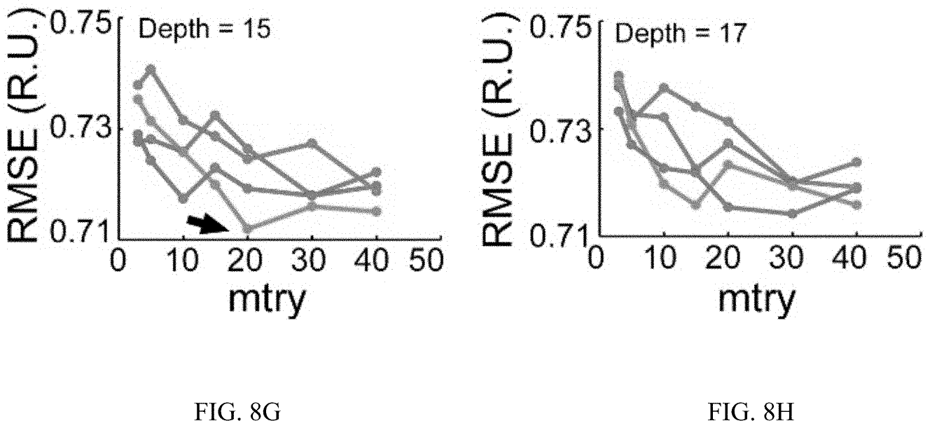

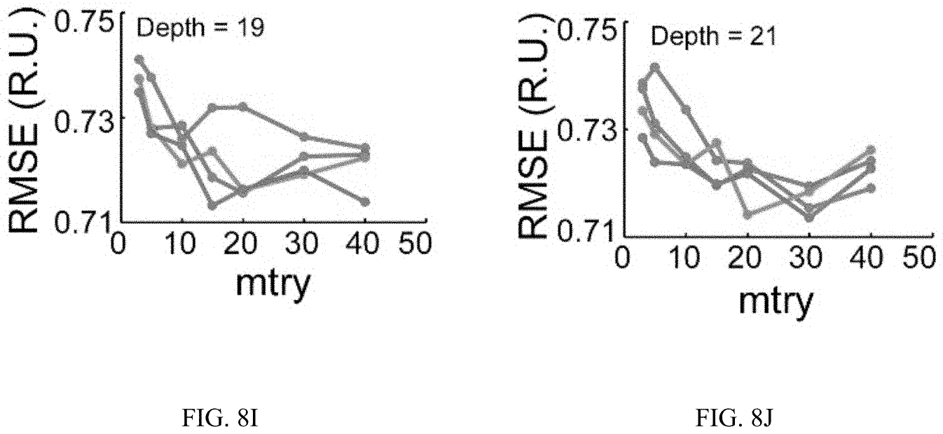

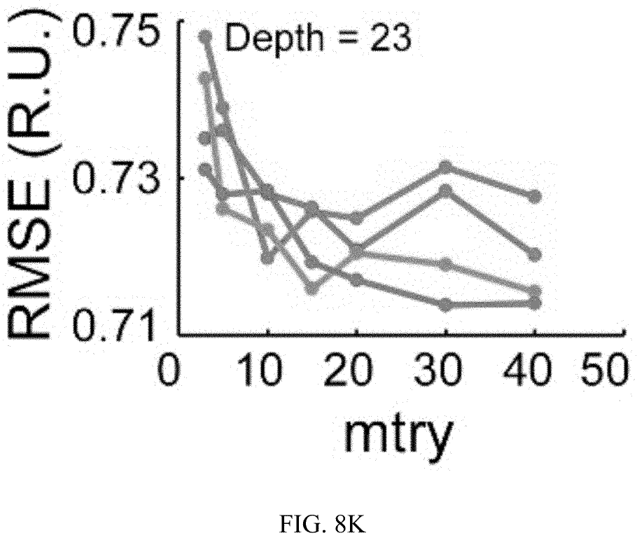

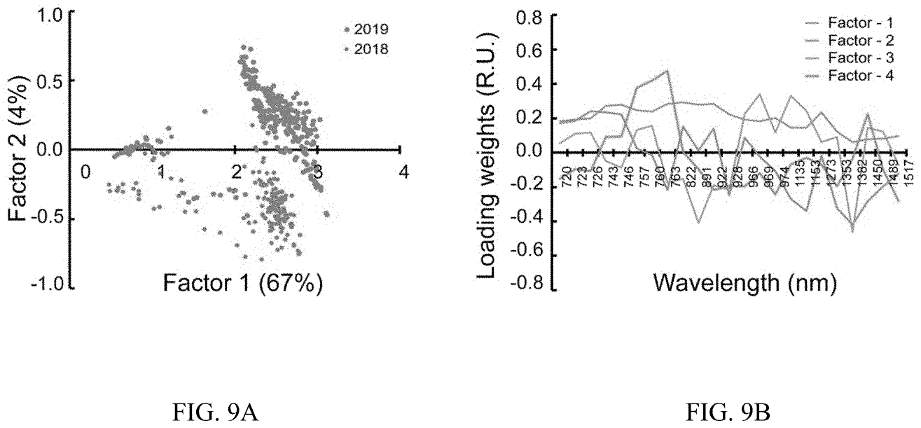

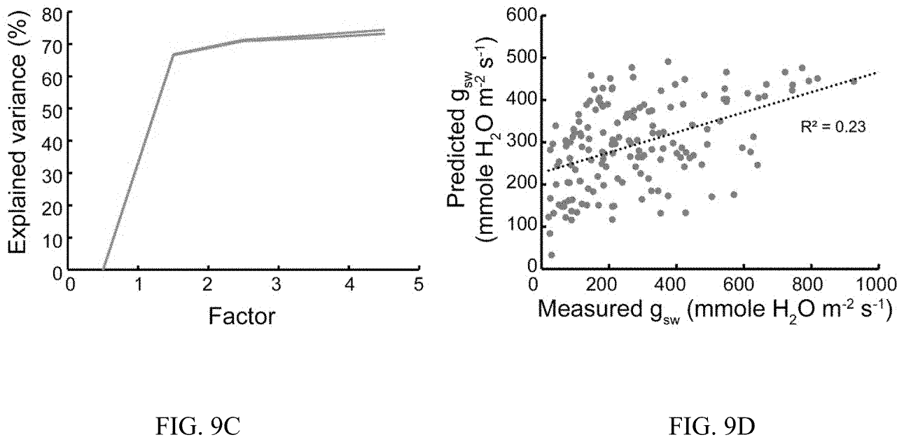

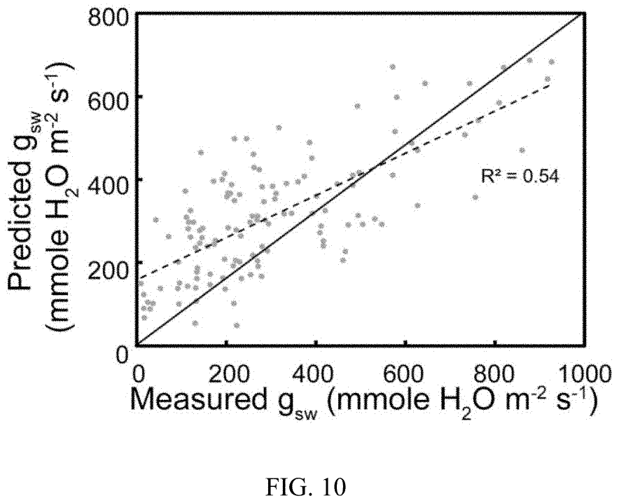

FIGS. 8A-8K are a presentation of all the Random Forest (RF) parameters combinations and their respective RMSE values between the average of stomatal conductance selected by the machine and the actual stomatal conductance average of the experiment. Mtry relates to the number of maximum samples divided between leaves of the regression tree; RMSE stands for the Root Mean Squared Error between the models selected samples average and the overall samples average. Curves represent the size of the RF (50, 100, 250, 500 regression trees); each represents a different depth of the regression tree starting at 3 for FIG. 8A and ending at 23 for FIG. 8K. Each point includes all the dataset (658 samples), repeated 5 times and averaged. The architecture of the RF selected for wavelength analysis is marked in bold black arrow in FIG. 8G. It had the lowest RMSE of all the combinations shown in the FIGS. 8A-8K.

This method may provide for increased resilience to over-fitting, well as an ability to flag important features within the measured spectrum. RF was pruned on three different levels, minimum number of samples in each node, and the maximum depth into which a tree may divide the data set. It can be seen that the lowest RMSE not necessarily reached for the largest forest, deepest trees diagrams with a maximal number of samples as would be naturally expected. Instead, the best architecture of the random forest was found to be at about two thirds of the maximum depth, with 20 samples minimum per node, and 250 trees in the forest (FIG. 8G, bold black arrow). The first 23 wavelengths were arbitrarily selected (corresponds to 10% of the wavelengths in the dataset) which were flagged by the algorithm as the most important. It was found that indeed the red-edge region keeps being selected here as one of the most important regions to detect stomatal conductance differences with remote sensing techniques, corroborating other simpler wavelength selection techniques used in this study (see Table 2 below).

TABLE 2
Important wavelengths in the selected Random Forest architecture
and their physiological meaning according to the literature.

| Feature | Importance | | |
|---|---|---|---|
| (nm) | (R.U.) | Meaning | Reference |
| 757 | 3.13 | Chlorophyll content, pest related, | Darmenda S, 2018 |
| | | Atmospheric oxygen absorption feature | Yang C M, 2007 |
| | | | Curran, 1989 |
| 760 | 2.98 | Atmospheric oxygen absorption feature, | Curran, 1989 |
| | | Chlorophyll content, Nitrogen | Rai S K, 2010 |
| | | concentration | Yi Q, 2008 |
| 726 | 2.65 | Red-edge, Chlorophyll content, | Zhang H, 2012 |
| | | | Wang J, 2018 |
| 1353 | 2.29 | Biochemical process, Lutein content, | Deel L N, 2010 |
| | | water content | Dvoracek V, 2018 |
| | | | Curran, 1989 |
| 922 | 2.06 | Moisture, Potassium level, Oil level | Alroichdi A M A, 2007 |
| | | | Peng U, 2020 |
| | | | Curran, 1989 |
| 754 | 1.95 | Disease related band (Anthracnose), | Yu P, 2020 |
| | | Atmospheric oxygen absorption feature | Curran, 1989 |
| 822 | 1.84 | Disease related band (Brown spot | Zhao J, 2012 |
| | | disease in rice) | |
| 723 | 1.71 | Leaf Area Index, Red-Edge | Junhua B, 2007 |
| | | | Curran, 1989 |
| 1455 | 1.43 | Lignin, Water content | Curran, 1989 |
| | | | Kusumo B H, 2009 |
| 1135 | 1.40 | Lignin, Dry matter, chlorophyll | Curran, 1989 |
| | | content | Clevers J, 2007 |
| | | | Osborne S L, 2002 |
| 974 | 1.29 | Water content | Velasco L, 1999 |
| | | | Rollin E M, 1998 |
| 1382 | 1.25 | Water content, Water molecules | Curran, 1989 |
| | | | Chatani E, 2014 |
| 1517 | 1.25 | Water Vapor, Protein, Nitrogen | Somdatta C, 2011 |
| | | | Curran, 1989 |
| 1152 | 1.21 | Pest Response related, Lignin | Mullen K E, 2016 |
| | | | Curran, 1989 |
| 1273 | 1.14 | Water, Lignin, Cellulose | Curran, 1989 |
| 746 | 1.13 | Fungal disease response related | Liu Z Y, 2008 |
| 968 | 1.12 | Water content | Penueals J 1995, |
| | | | Curran 1989 |
| 891 | 1.11 | Disease related | Jones C D, 2010 |
| 1489 | 1.04 | Cellulose, Sugar | Curran, 1989 |
| 762 | 0.97 | Nitrogen level, Fluorescence level | Basayigit L, 2007, |
| | | | Zarco-Tejada P J, |
| | | | 2003 |
| 743 | 0.97 | Plant-Pathogen interactions | Kuska M, 2015 |
| 928 | 0.92 | Oil | Curran, 1989 |
| 1433 | 0.90 | Unknown | |
| 721 | 0.89 | Chlorophyll related, Nitrogen related | Zhao D, 2003 |
| 966 | 0.87 | Water, Starch | Curran, 1989 |

Moreover, the RF algorithm also succeeded to pinpoint the fact that lignin is a very important feature to the detection of stomatal conductance, even more than water absorption bands. Mutations in lignin synthesizing enzymes has been shown to lower the turgor pressure of the plant and in general to decrease stomatal conductance and transpiration, therefore corroborating this finding (Bonawitz & Chapple, 2010). Lastly, the RF algorithm succeeded to show diseases and pathogens response wavelengths which are related to remote sensing of stomatal conductance. The relation between plant-pathogen interaction and stomatal conductance was highlighted in past studies- to name a few: attack of downy mildew on cucumber leaves (Lindenthal et al., 2005), carbon starvation in poplar stems by attack of fungi (Li et al., 2019) and transpiration decrease in anthracnose infection on bean plants (Lobato et al., 2010). Although these studies corroborate our findings, it should be noted that the pathogen or disease affect mostly other primary processes within the plant where attenuation in stomatal conductance is probably a secondary effect of the reaction of the plant to the stress in order to sustain photosynthetic activity.

### Index Assembly

Random Forest algorithm obtains the capability to predict parameters by its non-linear regression algorithm (Liaw & Wiener, 2002), yet the prediction algorithm is limited to the range of values that it was built upon during training of the model. Therefore, in search of a viable equation or model which can be used to calculate future stomatal conductance out of spectral information, a Multi-Linear Regression model was built. The model could not be assembled due to violation of the predominant assumption that each of the predictors obtain a partial linear relationship with the dependent variable. This is probably because some of the features selected by the RF mechanism are correlated. In order to neutralize the correlation, the data were projected into latent structure, to assemble a partial least squares regression (Wold et al., 2001).

FIGS. 8A-8B show construction of stomatal conductance index with Partial Least Squares Regression. FIGS. 8A-8C represent the model construction on 75% of the samples in the data (Calibration—494), and FIG. 8D shows a comparison between the predicted stomatal conductance by the model and the measured stomatal conductance on 25% of the samples (Test—164). FIG. 8A is a score plot of the calibration sub-set. Only the first two principal components out of total of four are shown. Colors represent the years. FIG. 8B is the loading weights plot of the calibration sub-set in each of the four principal components of the model and per wavelength selected by the RF algorithm. FIG. 8C shows the explained variance of the calibration sub-set together with a Leave-One-Out cross validation test on the same sub-set. FIG. 8D is the coefficient of determination representation of the correlation between the predicted and measured stomatal conductance.

The data was divided into 75%/25% training/testing subsets. During calibration of the model, the model presents a similar underlying representation of the stomatal conductance between the two years of experimentation, although the experiments in each year differed. Meaningful clusters were searched for within the scores plot without success—first by the discrete dates during each year, and water potentials, yet without success in association either classification. The calibration set was divided into four clusters using squared Euclidian distance range, however it was not correlated with any of the predictor classes, and therefore PLS-DA analysis could not be performed (Chevallier et al., 2006).

The best model was selected at four components where both the calibration and cross validation tests reached about 80% explained variance at the fourth principal component (FIG. 8C). Each component describes different relation with the spectrum (FIG. 8B), where: a. Factor—1-relates to tissue structural wavelengths (76%); b. Factor-2, -3 nm—relate to the water content in the plant (5%); and c. Factor-4 nm—to the oxygen absorption interference in the reflectance spectrum (2%). However, the projected model succeeded to predict only 23% of the behavior of the stomatal conductance in the test sub-set. Specifically, it can be seen that the model had difficulties to predict the stomatal conductance values at the range of 400-600 mmole H₂O m⁻² s⁻¹. These were usually the treatments with water potential of 18 Bars, where the cotton plant is irrigated adequately and the difficulty can be seen clearly when inspecting again FIG. 6A. While the 14 Bars treatments should have been at least at the same level of the 18 Bars treatment, it can be seen that it declines, even if not statistically significant, and that was probably the reason for the failure of the prediction model. This results implies that a PLS-R model can be used in order to detect stressed plant in terms of stomatal conductance.

In some embodiments, a standard back-propagated ANN with one hidden layer architecture was employed. The ANN model succeeded in creating a linear relation between 20 features out of the 24 features found originally by the RF algorithm. This model can calculate at an accuracy of 54%, stomatal conductance out of spectral information on the test-subset. ANN obtains an over-fitting problem which means that while it searches for the best correlation between the variables, it can be calibrated on internal noise within the data-set and thus not be able to predict the test set. Therefore, the performance of the procedure was verified (see Table 3) with various statistical tests.

TABLE 3
Artificial Neural Network performance values on construction of
stomatal conductance index. Initials stand for: MBE-Mean Biased
Error; MAE-Mean Absolute Error; RMSE-Root Mean Squared Error.

| Performance parameter | Train | Test |
|---|---|---|
| Correlation (R ) | 0.75 | 0.71 |
| Over/Under estimation | 0.02 | 0.03 |
| of model (MBE) | | |
| Absolute Error (MAE) | 0.43 | 0.59 |
| RMSE | 0.66 | 0.73 |
| “Error-Free” results | 0.93 | 0.82 |
| (d2 connectivity) | | |

The ANN architecture is able to correlate using Pearson correlation at 0.7 between the measured and predicted stomatal conductance. The “error-free” percentage of the model on the test set is 0.82 confidence with only decreasing in 0.1 units from the calibration set, implying for the strength of this model. Again, it can be seen that along the lower part of the curve the model is over-estimating the stomatal conductance with contribution of a bias term on the linear regression.

### Additional Experimental Results

The present inventors have conducted additional experimental results comprising two crop species, which were potted within a greenhouse experiment during winter.

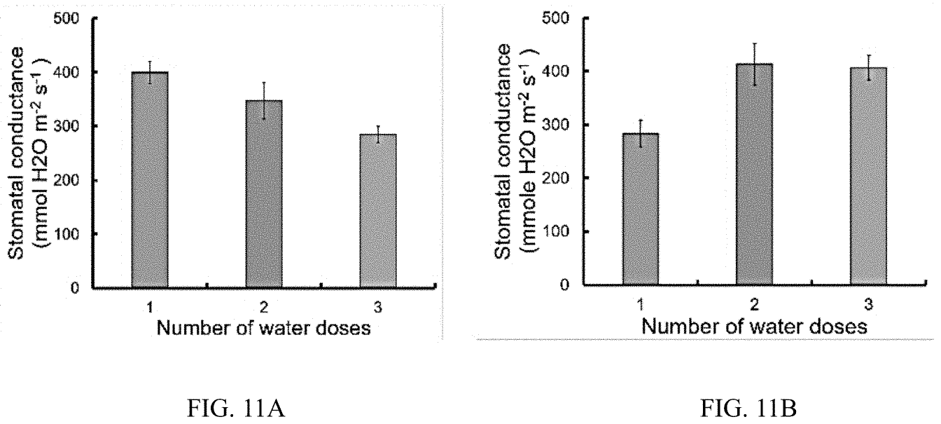

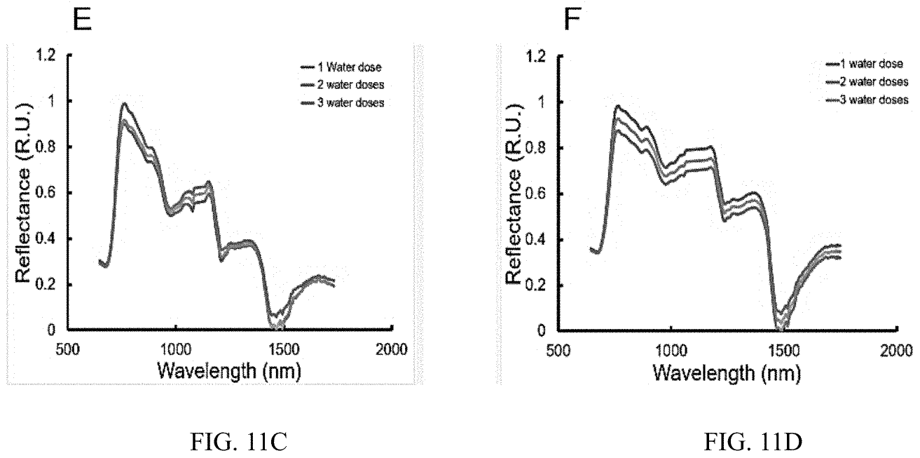

The crop species included cabbage and winter wheat. Three irrigation treatments were exercised on each of the species where 1, 2, and 3 doses of water volume per day were given to the plants, as can be seen in FIGS. 11A-11B, respectively. The 3 dose treatment received pot volume (5 L) at three time points along the day: at sunrise (05:00 AM), before noon (11:00 AM), and afternoon (05:00 PM). The 2 dose treatment received the same amount twice per day, at only sunrise and afternoon. The 1 dose received the same amount one per day, at sunrise.

The pot rows were divided into random localized 16 blocks where each irrigation treatment obtained 4 biological repeats. Within each repeat, 4 pot quads were used as technical repeats, to a total of 256 pots per crop species. Stomatal conductance was measured with a porometer (AP4, Delta-t, UK) four times per block, and was taken during each experimental day from random leaves within each block.

Spectral measurements were acquired with combined STS+Flame spectrometers (OceanInsight, FL, USA) in order to achieve a reflectance spectrum between 633 nm-1659 nm (FIGS. 11B-11D). The spectrometers were mounted on a handheld gimbal (Ronin MX, DJI, China) and 4 spectra were taken per block in a timed design sequence experiment in order to mimic a drone flight above the potted crops.

The imaging sensors were situated at arm height at 1.5 m above the crops. Overall, data from spectrometers and the porometer were collected simultaneously at 6 evenly spaced dates within the growing season, two times per day—at 08:30 AM and 11:30 AM. Overall, 600 simultaneous measurements of stomatal conductance and spectral acquisition were acquired.

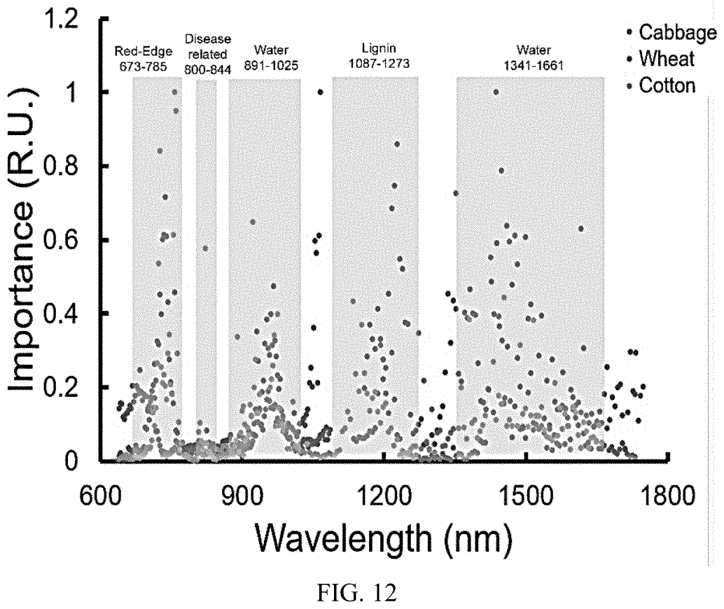

Data was pre-processed as explained hereinabove, and random forest of regression trees was constructed for the two crop species. In order to search for similar flagged wavelengths by the algorithm, the three crop species wavelengths importance results were range normalized in order to receive an interval of 0-1 for each crop importance wavelengths values and loaded onto one chart (FIG. 12).

In FIG. 12, cabbage, winter wheat and cotton are represented. Five spectral ranges are identified by the ensemble as important for remote sensing stomatal conductance which are mutual between crops:
(i) 673 nm-785 nm: Spectral range which includes Red Edge, an important physiological related spectral information. Foliar chemistry identifies chlorophyll a and b pigments within this region. Two atmospheric absorption bands of oxygen—O₂A and O₂B are found within the ˜687 nm and ˜760 nm in this region. These findings relate the spectral sensing of stomatal conductance directly to photosynthesis as the chlorophylls are light harvesting and reaction centers' pigments (photosynthetic apparatus pigments), and the two oxygen absorption bands overlap the fluorescence emitted from PhotoSystemII and PhotoSysteml (PSII and PSI, respectively), which reports indirectly on photosynthetic activity.
(ii) 800 nm-844 nm: This spectral range does not contain any known chemical component, however it has been recently identified with disease related indices.
(iii) 891 nm-1025 nm: This spectral range comprises a water absorption band found at 950-970 nm.
(iv) 1087 nm-1273 nm: Spectral range which reports on lignin content in the crop. Lignin is a bio-polymer which is very important to maintain mechanical structure of the plant. It is constructed and deposited within the secondary wall of the plant cells already during cells differentiation and growth. It is very important in maintaining turgor pressure and drought tolerance in crops, and its absence results in a detrimental effect on water vessels morphology.
(v) 1341 nm-1661 nm: Spectral range which is also affected by water absorption band at 1400 nm-1450 nm and in addition also contains information regarding the amount of cellulose and starch, two other important structural components of crops which are the immediate result of photosynthetic activity. This is because the two components are derivatives of long polysaccharide chains (sugars).

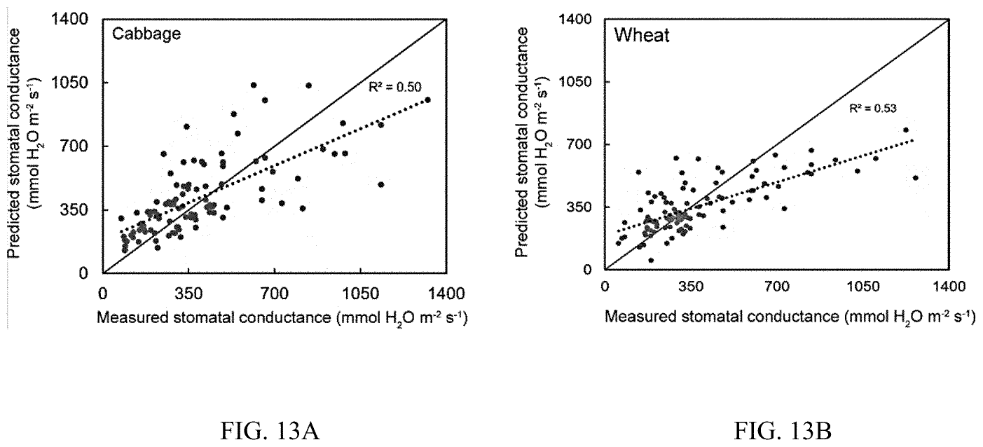

A machine learning model was trained on 10% of each of the most important wavelengths found by the Random Forest (RF) algorithm, as detailed hereinabove. This translates to a set of ˜23 wavelengths for each of the crops which are found within the four spectral ranges determined by the RF algorithm (FIG. 12). The machine learning model was developed on 75% of the dataset (432) samples, and was validated on the remaining 25% of the dataset per each crop (144 samples). The results are reported in FIGS. 13A-13B.

Both of the crops show a similar relation between ground truth and spectral measurement as cotton, where the coefficient of determination shows an R²>0.5. Performance of the ANN per crop was also calculated and showed that on average there is an 80% error-free prediction on the neural network side (Table 4).

TABLE 4
Machine learning model performance values.

| | Crop species | | | |
|---|---|---|---|---|
| | Cabbage | | Winter wheat | |
| Performance parameter | Training | Validation | Training | Validation |
| Correlation (R) | 0.65 | 0.72 | 0.75 | 0.71 |
| RMSE | 218.01 | 189.9 | 147.16 | 183.76 |
| “Error-Free” prediction | 0.8 | 0.83 | 0.86 | 0.79 |
| (d2 connectivity) | | | | |

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1. A method comprising:
receiving by a trained machine learning model, as input at an inference stage, a target spectral data sample, wherein said spectral data samples represents spectral reflectance from a target plant;
(i) and, applying said trained machine learning model to said target spectral data sample associated with said target plant, to predict a stomatal conductance value for said target plant.

2. The method of claim 1, wherein said trained machine learning model is trained by:
receiving, as input at a training stage, a training set comprising:
(i) a plurality of spectral data samples wherein each of said spectral data samples represent spectral reflectance from a plant, and
(ii) labels associated with stomatal conductance in each of said plants,
wherein said spectral data samples in said training set are labeled with said labels.

3. The method of claim 2, wherein said spectral data samples are obtained by measuring reflected light from a canopy of said plant.

4. The method of claim 2, wherein said spectral data samples are obtained by remote sensing techniques.

5. The method of claim 2, further comprising a preprocessing step configured for reducing a number of wavelengths in each of said spectral data samples.

6. The method of claim 5, wherein said preprocessing comprises at least one of: box-car averaging, removal of outlier spectra, applying standard normal variate (SNV) analysis, base-line correction, normalization to the maximum peak within each spectrum, and scaling.

7. The method of claim 5, further comprising performing a feature selection stage to select an optimal subset of wavelengths from said reduced number of wavelengths, wherein said training set comprises only said optimal subset of spectral bands from each of said spectral data samples.

8. The method of claim 7, wherein said feature selection stage is performed using a regression tree algorithm.

9. The method of claim 8, wherein said regression tree algorithm is a random forest algorithm with pruning.

10. The method of claim 1, wherein said stomatal conductance is indicative of a water stress status in said target plant.

11. A system comprising:
at least one hardware processor; and
a non-transitory computer-readable storage medium having stored thereon program instructions, the program instructions executable by the at least one hardware processor to:
receive, as input, a plurality of spectral data samples, wherein each of said spectral data samples represents spectral reflectance from a plant;
at a training stage, train a machine learning model on a training set comprising:
(i) said spectral data samples, and
(ii) labels associated with stomatal conductance in each of said plants wherein said spectral data samples in said training set are labeled with said labels; and
at an inference stage, apply said machine learning model to a target spectral data sample associated with a target plant, to predict a stomatal conductance value for said target plant.

12. (canceled)

13. (canceled)

14. (canceled)

15. The system of claim 11, further comprising a preprocessing step configured for reducing a number of wavelengths in each of said spectral data samples.

16. The system of claim 15, wherein said preprocessing comprises at least one of: box-car averaging, removal of outlier spectra, applying standard normal variate (SNV) analysis, base-line correction, normalization to the maximum peak within each spectrum, and scaling.

17. The system of claim 15, further comprising performing a feature selection stage to select an optimal subset of wavelengths from said reduced number of wavelengths, wherein said training set comprises only said optimal subset of spectral bands from each of said spectral data samples.

18. (canceled)

19. (canceled)

20. The system of claim 11, wherein said stomatal conductance is indicative of a water stress status in said target plant.

21. (canceled)

22. (canceled)

23. (canceled)

24. (canceled)

25. (canceled)

26. (canceled)

27. (canceled)

28. (canceled)

29. (canceled)

30. (canceled)

31. The system of claim 11
wherein the spectral data comprises:
(i) spectral data in a spectral band comprising wavelengths from 1087-1273 nm; and
(ii) spectral data in at least one spectral band selected from the group of spectral bands comprising wavelengths from: 673 nm-785 nm, 800 nm-844 nm, 891 nm-1025 nm, and 1341 nm-1661 nm.

32. The system of claim 31, wherein said spectral data is received from an imaging module comprising a set of imaging sensors, each configured to capture spectral reflectance in only one spectral band selected from the group of spectral bands comprising wavelengths from: 673-785 nm, 800-844 nm, 891-1025 nm, 1087-1273 nm, and 1341-1661 nm.

33. The method according to claim 2,
wherein the spectral data comprises:
(i) spectral data in a spectral band comprising wavelengths from 1087-1273 nm; and
(ii) spectral data at least one spectral band selected from the group of spectral bands comprising wavelengths from: 673-785 nm, 800-844 nm, 891-1025 nm, and 1341-1661 nm.

34. The method of claim 33, wherein said spectral reflectance data is received from an imaging module comprising a set of imaging sensors, each configured to capture spectral reflectance in only one spectral band selected from the group of spectral bands comprising wavelengths from: 673-785 nm, 800-844 nm, 891-1025 nm, 1087-1273 nm, and 1341-1661 nm.

35. (canceled)

36. (canceled)

37. A method for remote sensing of stomatal conductance in a plant, the method comprising:
receiving, as input, a plurality of spectral data samples, wherein each of said spectral data samples represents spectral reflectance from a plant in a set of spectral wavelengths;
applying a random forest regression tree algorithm to said spectral data samples, to identify a subset of said spectral wavelengths, based on a spectral wavelength importance measure,
wherein said random forest regression tree algorithm comprises pruning associated with at least one of:
(i) a total number of decision trees;
(ii) a constant value of samples within a single node of each of said decision trees; and
(iii) a maximum depth of said regression tree;
receiving a target spectral data sample associated with a target plant; and
predicting a stomatal conductance value for said target plant, based on said spectral data associated with said subset of spectral wavelengths in said spectral data sample.
